(19) United States
(12) Patent Application Publication
(10) Pub. No.: US 2025/0220714 A1
(43) Pub. Date: Jul. 3, 2025

(54) Data Unit Delivery for Relay Communications

(71) Applicant: Ofinno, LLC, Reston, VA (US)

(72) Inventors: Serhat Erkucuk, Reston, VA (US); Leonardo Alisasis Lanante, Reston, VA (US); Esmael Hejazi Dinan, McLean, VA (US); Jeongki Kim, Fairfax, VA (US); Tuncer Baykas, Reston, VA (US); Jiayi Zhang, Rockville, MD (US)

(21) Appl. No.: 19/001,738

(22) Filed: Dec. 26, 2024

Related U.S. Application Data
(60) Provisional application No. 63/616,106, filed on Dec. 29, 2023.

(51) Int. Cl. H04W 74/0816; H04W 8/22; H04W 28/02; H04W 74/08

(52) U.S. Cl. CPC H04W 74/0816; H04W 8/22; H04W 28/0278; H04W 74/0866

(57) ABSTRACT

A first station (STA) receives, from a second STA, one or more first frames including a first data unit and a second data unit, following the first data unit, for transmission by the first STA to a third STA, and an indication of whether transmission of the second data unit before the first data unit is allowed. The first STA transmits, to the third STA, a second frame including one or more of the first and the second data units, based on the indication.

### CROSS-REFERENCE TO RELATED APPLICATIONS

This application claims the benefit of U.S. Provisional Application No. 63/616,106, filed Dec. 29, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example of a sub-1 GHz (S1G) relay architecture.

FIG. 7 illustrates an example of source-relay-destination link.

FIG. 8 is an example that illustrates relaying with no transmission opportunity (TXOP) protection.

FIG. 9 illustrates an example of Request-to-Send (RTS)/Clear-to-Send (CTS) procedure.

FIG. 10 is an example that illustrates relaying with TXOP protection.

FIG. 11 illustrates an example of a reorder buffer operation at a recipient STA.

FIG. 12 illustrates an example of a relaying procedure, which may be used for relaying downlink traffic from an AP to a STA.

FIG. 13 illustrates another example of a relaying procedure, which may be used for relaying downlink traffic from an AP to a STA.

FIG. 14 illustrates another example of a relaying procedure, which may be used for relaying downlink traffic from an AP to a STA.

FIG. 15 illustrates an example process, according to an embodiment.

FIG. 16 illustrates an example of a relaying procedure, which may be used for relaying downlink traffic from an AP to a STA, according to an embodiment.

FIG. 17 illustrates another example of a relaying procedure, which may be used for relaying downlink traffic from an AP to a STA, according to an embodiment.

FIG. 18 illustrates another example of a relaying procedure, which may be used for relaying downlink traffic from an AP to a STA, according to an embodiment.

FIG. 19 illustrates another example of a relaying procedure, which may be used for relaying downlink traffic from an AP to a STA, according to an embodiment.

FIG. 20 illustrates another example of a relaying procedure, which may be used for relaying downlink traffic from an AP to a STA, according to an embodiment.

FIG. 21 illustrates another example of a relaying procedure, which may be used for relaying downlink traffic from an AP to a STA, according to an embodiment.

FIG. 22 illustrates another example of a relaying procedure, which may be used for relaying downlink traffic from an AP to a STA, according to an embodiment.

FIG. 23 illustrates an example PPDU that may be used in an embodiment.

FIG. 24 illustrates an example process according to an embodiment.

FIG. 25 illustrates another example process according to an embodiment.

FIG. 26 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described example embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

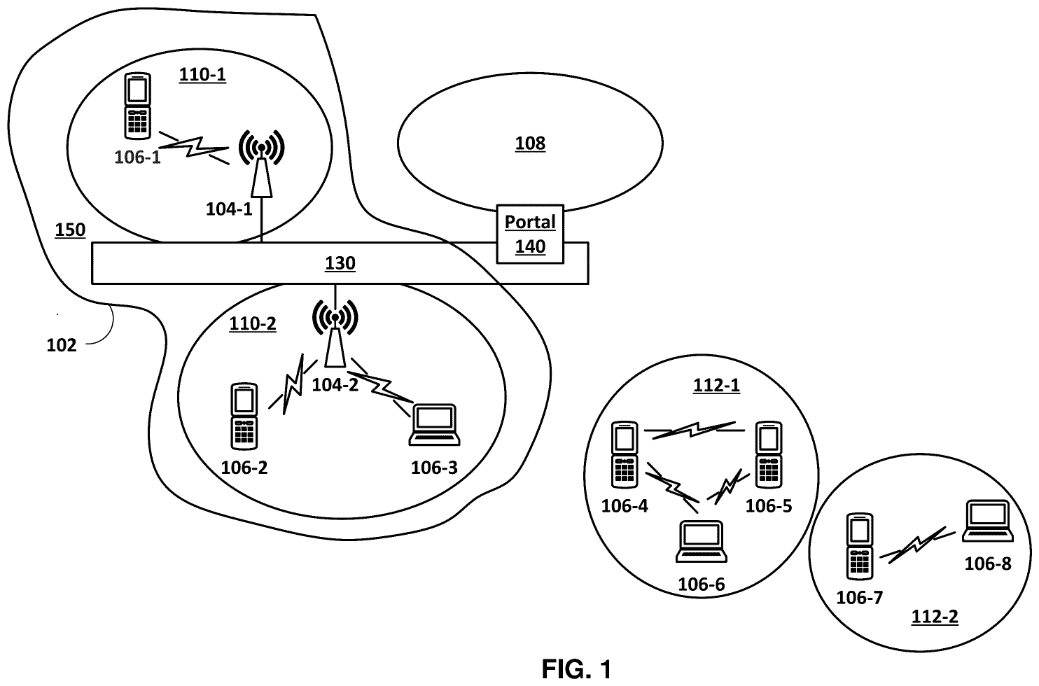

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

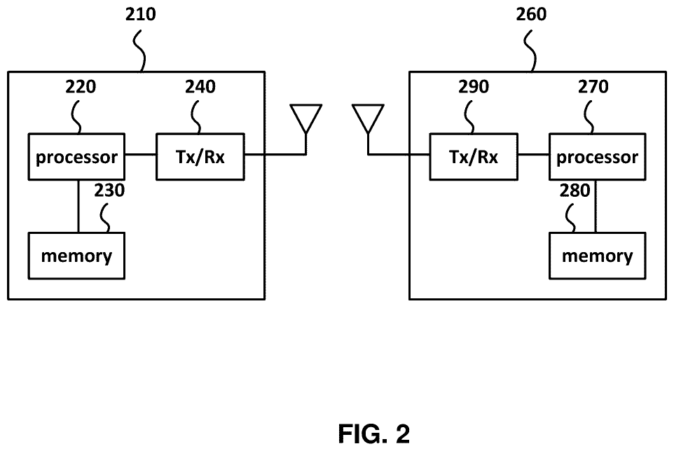

FIG. 2 is a block diagram illustrating example implementations of a STA 210 and an AP 260.

As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

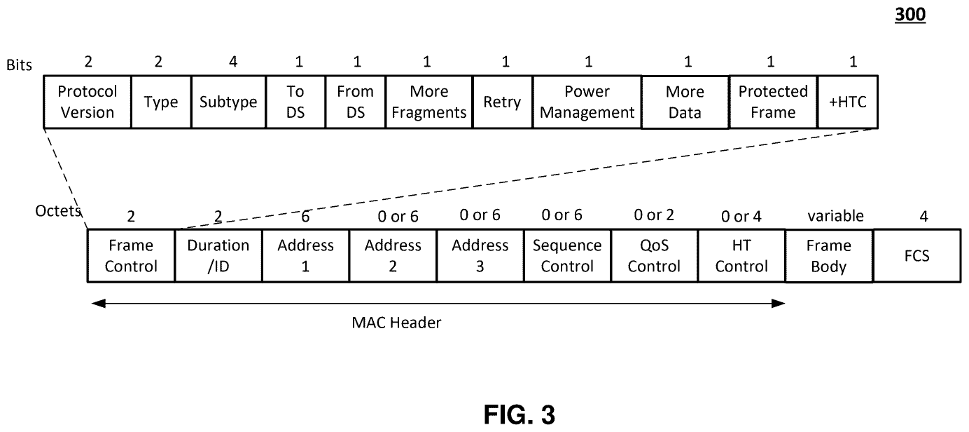

FIG. 3 illustrates an example 300 of a MAC frame format. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

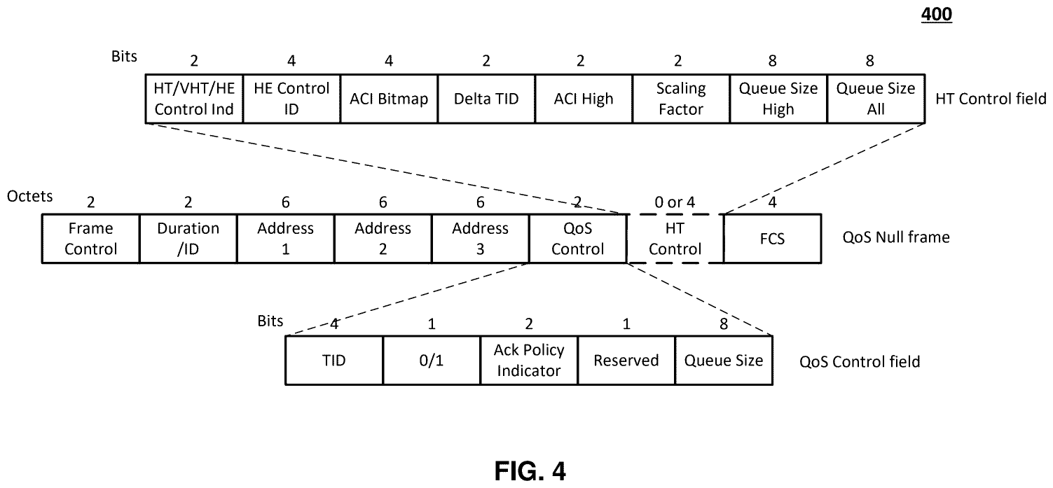

FIG. 4 illustrates an example 400 of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

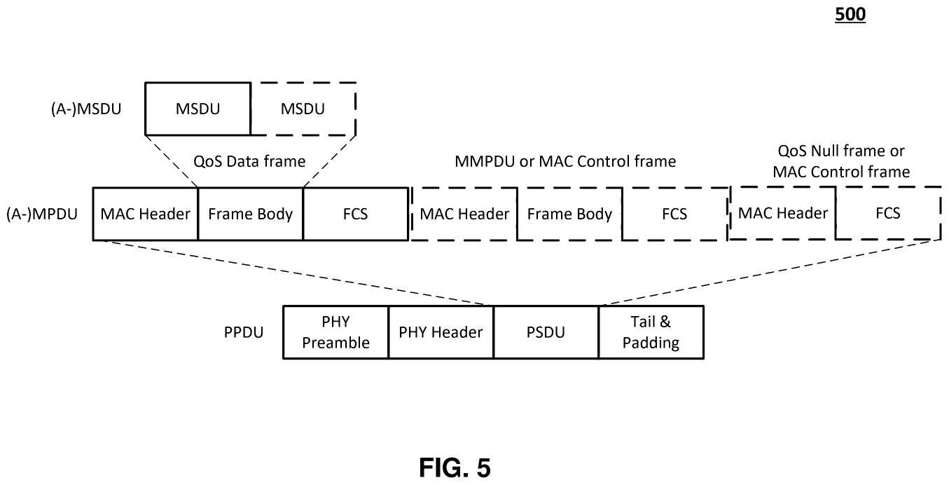

FIG. 5 illustrates an example format of a PPDU 500. As shown, the PPDU 500 may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

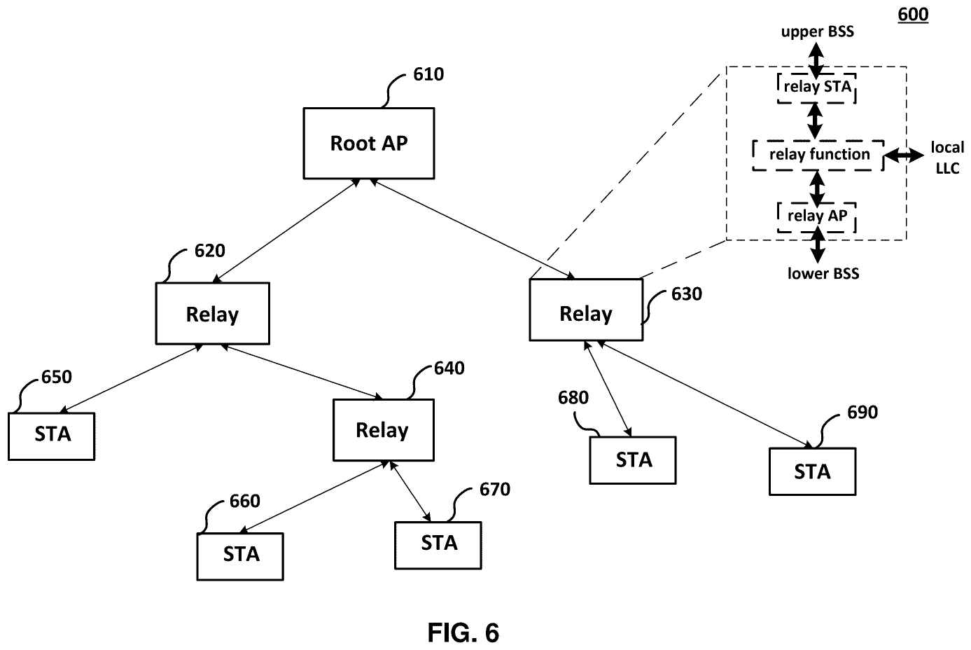

FIG. 6 illustrates an example of a sub-1 GHz (S1G) relay architecture 600. Example S1G relay architecture 600 may be an example according to the S1G relay operation as defined in section 10.54.1 of the IEEE 802.11 standard draft “IEEE P802.11-REVme™/D2.1, January 2023.” As shown in FIG. 6, example S1G relay architecture 600 may include a root AP 610, relays 620, 630 and 640, and STAs 650, 660, 670, 680 and 690.

S1G relay is a mechanism for expanding the coverage area of an AP, referred to as the root AP. In example S1G relay architecture 600, the S1G relay mechanism is being used to expand the coverage area of root AP 610.

As shown in FIG. 6, S1G relays 620, 630 and 640 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 620 and 630 are associated with root AP 610. Relay 640 may be associated with relay 620. In an example, STA 650 is associated with relay 620. STAs 660 and 670 may be associated with relay 640. STAs 680 and 690 may be associated with relay 630.

In an example, frames from STA 650 are forwarded via the relay function of relay 620 (from the relay AP to the relay STA of relay 620) to root AP 610. In the reverse direction, frames from root AP 610 are forwarded to STA 650 via the relay function of relay 620 (from the relay STA to the relay AP of relay 620). Similarly, STAs 680 and 690 may communicate with root AP 610 via relay 630 in both directions (e.g., uplink and downlink). On the other hand, STAs 660 and 670 may use relays 640 and 620 consecutively to communicate with root AP 610.

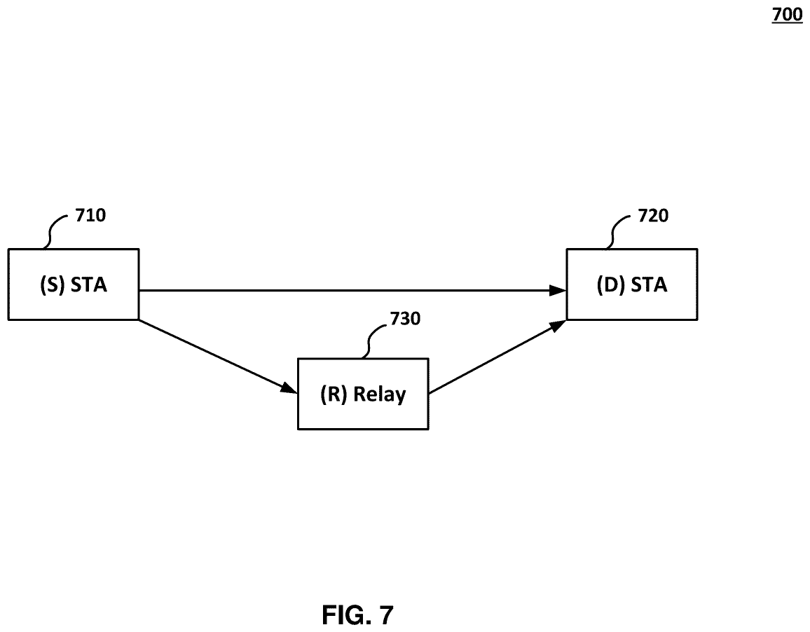

FIG. 7 illustrates an example of a source-relay-destination link 700. As shown in FIG. 7, source-relay-destination link 700 may comprise a STA 710 as a source STA, a STA 720 as a destination STA, and a relay 730.

STA 710 may be a non-AP STA or an AP STA. Similarly, STA 720 may be a non-AP STA or an AP STA. Relay 730 may comprise a relay AP, a relay STA, and a relay function as described in FIG. 7 above. In an embodiment, STA 710 may be an AP STA and STA 720 may be a non-AP STA, or vice versa. In another embodiment, STAs 710 and 720 both may be AP STAs or non-AP STAs. STAs 710 and 720 may communicate directly.

Due to unreliable communication or to extend the range of existing communication, source STA 710 may use relay 730 to communicate with a destination STA 720. As such, STA 710 may transmit data frames destined to STA 720 via relay 730. Source STA 710 and/or the relay 730 may choose to protect the transmitted data frames with TXOP protection while relaying the data frames via relay 730. In another embodiment, source STA 710 and/or relay 730 may choose not to protect the data frames with TXOP protection while relaying the data frames via relay 730.

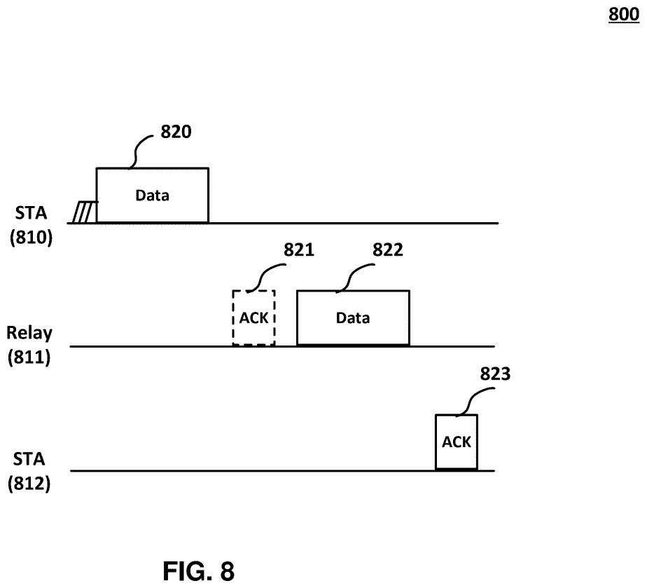

FIG. 8 is an example 800 that illustrates relaying with no transmission opportunity (TXOP) protection. Example 800 may be an example according to the TXOP sharing procedures for S1G relay operation as defined in section 10.54.5 of the IEEE 802.11 standard draft “IEEE P802.11-REVme™/D2.1, January 2023.” As shown in FIG. 8, example 800 may include STAs 810 and 812 and relay 811.

In example 800, STA 810 may be a STA that supports TXOP sharing procedures. As shown in FIG. 8, STA 810 may transmit a data frame 820 destined to STA 812 via relay 811. Data frame 820 may be a protocol version 1 (PV1) QoS data frame. In an implementation, STA 810 may set a Relayed Frame field in a Frame Control field of data frame 820 to 1. The Relayed Frame field set to 1 indicates a relay-shared TXOP. On receiving data frame 820 with the Relay Frame field set to 1, relay 811 may transmit an ACK frame 821 if an explicit ACK procedure is used. Alternatively, relay 811 may not transmit an ACK frame if an implicit ACK procedure is used.

In example 800, relay 811 may transmit data frame 822 to STA 812 without protecting data frame 822. STA 812 may transmit an ACK frame 823 after receiving data frame 822 from relay 811. Relaying without TXOP protection may allow a lower latency transmission of data frame 820 from STA 810 to STA 812. However, communication may be less reliable in case that other STAs of the same BSS may be present within the communication ranges of STAs 810, 812 and relay 811. To improve communication reliability, an RTS/CTS procedure may be used to protect relayed data frames as further described below.

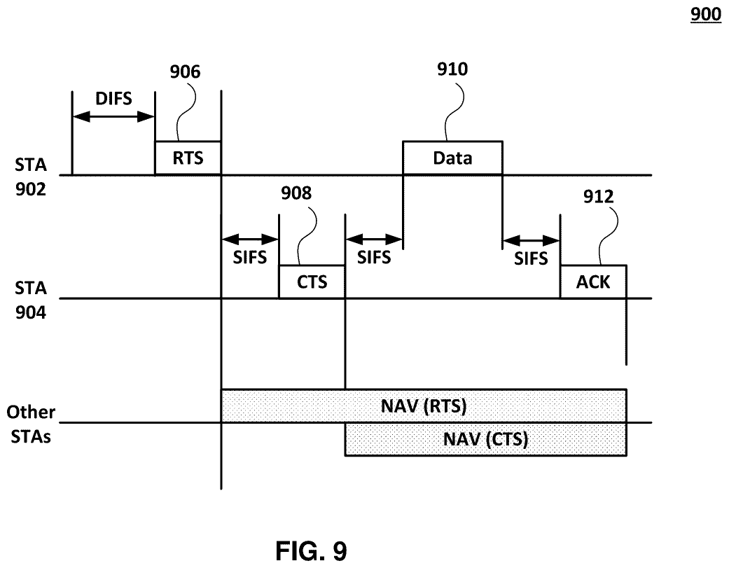

FIG. 9 illustrates an example 900 of a Request-to-Send (RTS)/Clear-to-Send (CTS) procedure. Example RTS/CTS procedure 900 may be an example according to the RTS/CTS procedure as defined in section 10.3.2.9 of the IEEE 802.11 standard draft “IEEE P802.11-REVme™/D2.1, January 2023.” As shown in FIG. 9, example RTS/CTS procedure 900 may include STAs 902 and 904. Other STAs of the same BSS may also be within communication range of STAs 902 and 904.

In an example, STA 902 may transmit an RTS frame 906 to STA 904. STA 902 may transmit RTS frame 906 to protect from hidden STA(s) the transmission of a data frame 910 that STA 902 intends to transmit. RTS frame 906 may include a Duration/ID field. The Duration/ID field may be set to the time, in microseconds, required to transmit data frame 910, plus one CTS frame, plus one ACK frame (if required), plus three SIFS (Short Interframe Spacing) periods.

In an example, STA 904 may respond to RTS frame 906 by transmitting a CTS frame 908 to STA 902. CTS frame 908 may be transmitted one SIFS period after RTS frame 906. STA 904 may respond to RTS frame 906 when RTS frame 906 is addressed to STA 904 and after considering the NAV, unless the NAV was set by a frame originating from STA 902. STA 904 may respond to the RTS frame 906 when RTS frame 906 is addressed to STA 904 and if the NAV indicates idle. For a non-S1G STA, the NAV indicates idle when the NAV count is 0 or when the NAV count is non-zero but a nonbandwidth signaling TA obtained from a TA field of RTS frame 906 matches a saved TXOP holder address. For an S1G STA, the NAV indicates idle when both the NAV and RID (response indication deferral) counters are 0 or when either the NAV or RID counter is non-zero but the TA field of RTS frame 906 matches the saved TXOP holder address.

STA 904 may set an RA field of CTS frame 908 to a nonbandwidth signaling TA obtained from the TA field of RTS frame 906. STA 904 may set a Duration field of CTS frame 908 based on the Duration/ID field of RTS frame 906, namely as equal to the value of the Duration/ID field of RTS frame 906, adjusted by subtracting the time required to transmit CTS frame 908 and one SIFS period.

Upon receiving CTS frame 908, STA 902 may wait one SIFS period before transmitting data frame 910. STA 904 may transmit an ACK frame 912 in response to data frame 910. STA 904 may transmit ACK frame 912 one SIFS after receiving data frame 910.

As shown in example 900, other STAs within communication range of STAs 902 and 904, and belonging to the same BSS, may set their NAVs according to RTS frame 906 and/or CTS frame 908. For example, a STA receiving RTS frame 906 may set its NAV based on the Duration/ID field of RTS frame 906. Another STA receiving CTS frame 908 may set its NAV based on the Duration field of CTS frame 908. As such, the other STAs may not access the channel using EDCA until the end of transmission of ACK frame 912.

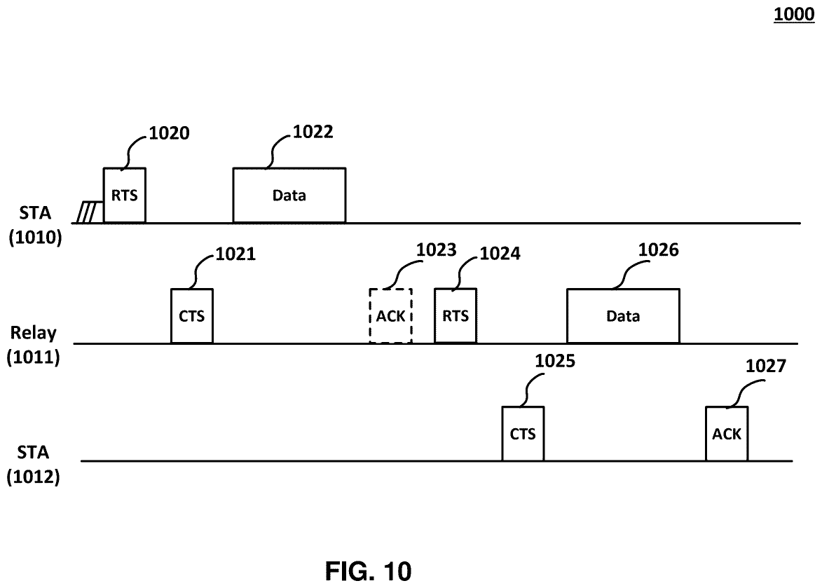

FIG. 10 is an example 1000 that illustrates relaying with TXOP protection. Example 1000 may be an example according to the TXOP sharing procedures for S1G relay operation as defined in section 10.54.5 of the IEEE 802.11 standard draft “IEEE P802.11-REVme™/D2.1, January 2023.” As shown in FIG. 10, example 1000 may include STAs 1010 and 1012 and relay 1011.

In an example, STA 1010 may be a STA that supports TXOP sharing procedures. Before transmitting a data frame 1022 to relay 1011, STA 1010 may transmit an RTS frame 1020 to relay 1011. Relay 1011 may respond to RTS frame 1020 by transmitting a CTS frame 1021 to STA 1010, if its NAV indicates idle. Upon receiving CTS frame 1021, STA 1010 may transmit data frame 1022 to relay 1011. Relay 1011 may transmit an ACK frame 1023 if an explicit ACK procedure is used. Alternatively, relay 1011 may not transmit an ACK frame if an implicit ACK procedure is used.

Similarly, before relaying receive data frame 1022 onto STA 1012, relay 1011 may transmit an RTS frame 1024 to STA 1012. STA 1012 may respond to RTS frame 1024 by transmitting a CTS frame 1025 to relay 1011, if its NAV indicates idle. Upon receiving CTS frame 1025, relay 1011 may transmit a data frame 1026 (relay of data frame 1022) to STA 1012. STA 1012 may transmit an ACK frame 1027 to relay 1011 after receiving data frame 1026.

Relaying with TXOP protection provides a more reliable approach to transmit data frames from a source STA to a destination STA. This may be achieved by using the RTS/CTS procedure sequentially in source-to-relay and relay-to-destination links. However, where the relay-to-destination link is not available due to a busy medium, there may be a delay until the relay receives a CTS frame from the destination STA and can transmit the data frame to the destination STA. An end-to-end approach that provides TXOP protection for both links may thus be more suitable to prevent any such delays.

According to the IEEE 802.11 standard, when a recipient STA receives from an originator STA an MPDU comprising a QoS data frame for which a block ack session is in place, the recipient STA buffers an MSDU (or an A-MSDU) contained in the QoS data frame when the MPDU is received successfully. If the MSDU is at the head of a reorder buffer of the recipient STA, then the recipient STA forwards the MSDU to a higher layer (e.g., LLC) of the recipient STA. The recipient STA may then forward subsequent MSDUs in the reorder buffer in sequence to the higher layer until an MSDU hole in the reorder buffer (e.g., an MSDU hole corresponds to a gap in the reorder buffer due to an MSDU being missing from the reorder buffer, e.g., due to being received in error, and that creates an MSDU sequence number gap in the reorder buffer) is encountered. If, when the MSDU arrives, there are MSDUs with lower sequence numbers than the arriving MSDU that are missing in the reorder buffer, then the MSDU is held until those preceding MSDUs are added to the buffer. The forwarding of MSDUs in sequence (in accordance with consecutive sequence numbers) to a higher layer may be referred to as in order (IO) delivery or in sequence delivery.

While IO delivery is suitable for IEEE 802.11 based operations under normal conditions, if missing preceding MSDUs in the reorder buffer are not completed in upcoming retransmissions, the recipient STA may not forward successfully received MSDUs that are in sequence after an MSDU hole, to a higher layer. As such, there may be delays in the forwarding of MSDUs in the reorder buffer to a higher layer, which may result in degraded performance particularly when the successfully received MSDUs comprise high priority (e.g., low latency) data units. With supporting low latency transmission being a main design consideration for future IEEE 802.11 radios, forwarding successfully received MSDUs to a higher layer without waiting for the completion of missing preceding MSDUs in the reorder buffer may be considered in future generations of the IEEE 802.11 standard. Such forwarding of MSDUs to a higher layer may be referred to as out-of-order (OOO) delivery.

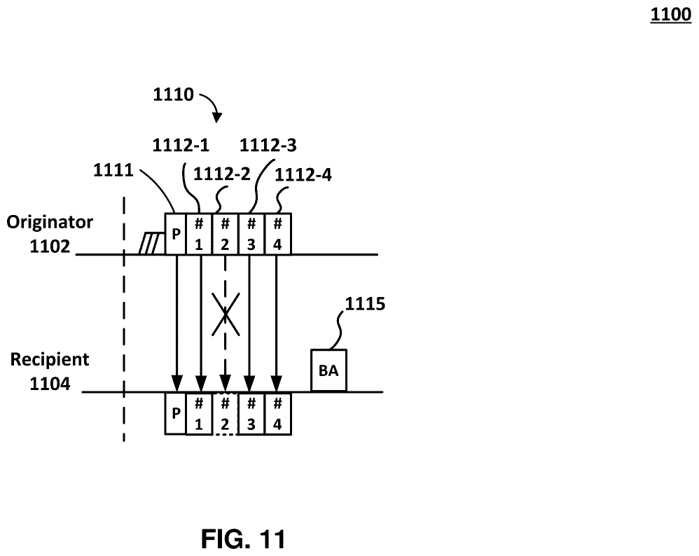

FIG. 11 illustrates an example 1100 of a reorder buffer operation at a recipient STA. As shown in FIG. 11, example 1100 may include an originator STA 1102 and a recipient STA 1104. In an example, originator STA 1102 may be an AP STA or a non-AP STA. In an example, recipient STA 1104 may be an AP STA or a non-AP STA. Recipient STA 1104 may implement a reorder buffer (not shown in FIG. 11) which operation is further described below.

As shown in FIG. 11, originator STA 1102 may transmit a frame 1110 to recipient STA 1104. In an example, frame 1110 may be a PPDU comprising a unit 1111 and data units 1112-1, 1112-2, 1112-3 and 1112-4. Unit 1111 may comprise a PHY preamble and a PHY header (collectively denoted “P” in frame 1110). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 1100, data units 1112-1, 1112-2, 1112-3 and 1112-4 may comprise sequence numbers 1, 2, 3 and 4, respectively, as illustrated in FIG. 11. In an example, frame 1110 may further comprise a block ack request (BAR) (not shown in FIG. 11). When present, the BAR indicates that originator STA 1102 requests a block ack (BA) frame in response to frame 1110.

On receiving frame 1110, recipient STA 1104 may decode frame 1110, including decoding each of data units 1112-1, 1112-2, 1112-3, and 1112-4. A data unit that recipient STA 1104 can decode successfully (e.g., for which an FCS check is successful) may be considered as received successfully by STA 1104. In contrast, a data unit that recipient STA 1104 fails to decode successfully (e.g., for which an FCS check fails) may be considered as received in error by STA 1104. In example 1100, it is assumed data units 1112-1 (with sequence number 1), 1112-3 (with sequence number 3), and 1112-4 (with sequence number 4) are received successfully by recipient STA 1104 but that data unit 1112-2 (with sequence number 2) is received in error by recipient STA 1104.

In the reorder buffer operation described herein, the MSDUs of data units that are received successfully by recipient STA 1104 are placed in the reorder buffer of STA 1104 according to their sequence numbers. The MSDUs of data units that are received in error by recipient STA 1104 are not placed in the reorder buffer and their corresponding locations in the reorder buffer are kept empty (e.g., creating one or more MSDU holes in the reorder buffer). As such, in example 1100, the reorder buffer of recipient STA 1104 may comprise MSDUs of data units 1112-1, 1112-3, and 1112-4 associated with sequence numbers 1, 3 and 4. However, as data unit 1112-2 is received in error by recipient STA 1104, the reorder buffer may not include the MSDU of data unit 1112-2 (associated with sequence number 2), resulting in an MSDU hole in the reorder buffer.

In an example, recipient STA 1104 may support IO delivery. As such, only MSDUs that precede an MSDU hole in the reorder buffer are forwarded to a higher layer. In example 1100, as data unit 1112-2 is received in error, the MSDU of data unit 1112-1 (associated with sequence number 1) is the only MSDU that precedes the MSDU hole created by the erroneous reception of data unit 1112-2. Accordingly, only the MSDU of data unit 1112-1 is forwarded to a higher layer until data unit 1112-2 is received successfully. That is, recipient STA 1104 has to receive data unit 1112-2 (with sequence number 2) successfully before STA 1104 can forward MSDUs of data units 1112-3 and 1112-4 (with sequence numbers 3 and 4, respectively) to a higher layer.

In another example, recipient STA 1104 may support OOO delivery. As such, all MSDUs in the reorder buffer, regardless of their positions relative to any MSDU hole in the reorder buffer, are forwarded to a higher layer. In example 1100, as the MSDUs of data units 1112-1, 1112-3 and 1112-4 (associated with sequence numbers 1, 3 and 4, respectively) are all complete (e.g., in the reorder buffer), the MSDUs of data units 1112-1, 1112-3, and 1112-4 are forwarded to the higher layer, despite data unit 1112-2 associated with sequence number 2 being received in error.

In an example, recipient STA 1104 may transmit to originator STA 1102 a BA frame 1115 indicating data unit 1112-2 was received in error. Originator STA 1102 may retransmit data unit 1112-2 to STA 1104 in a subsequent frame (not shown in FIG. 11).

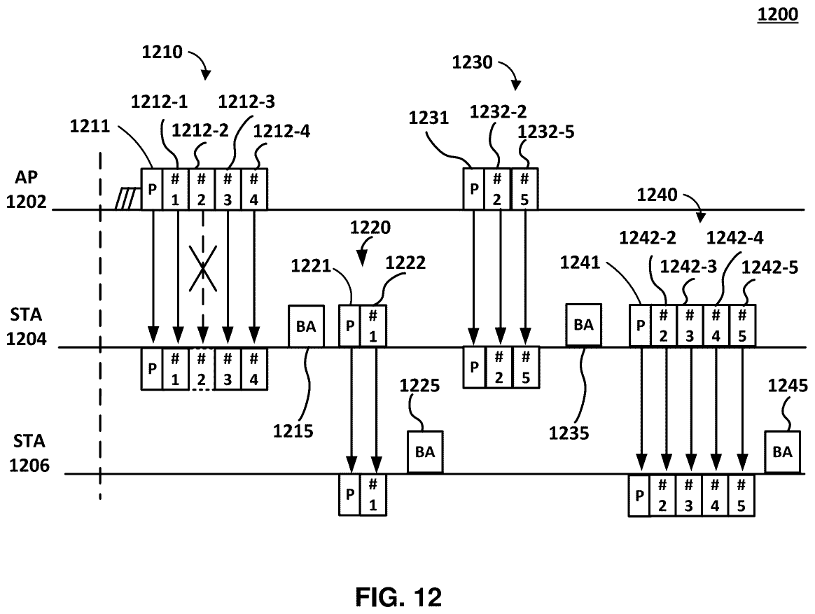

FIG. 12 illustrates an example 1200 of a relaying procedure, which may be used for relaying downlink traffic from an AP to a STA. As shown in FIG. 12, example 1200 may include an AP 1202 and a plurality of STAs 1204 and 1206. In an example, STAs 1204 and 1206 may be associated with AP 1202. In an example, AP 1202 and STAs 1204 and 1206 may be within each other's communication ranges. In an example, STA 1204 may receive data frames from AP 1202 destined to itself. In another example, STA 1204 may serve as a relay for STA 1206. For instance, AP 1202 may be configured to transmit a PPDU to STA 1206 via STA 1204 in order to increase the throughput of a downlink transmission. For the purpose of illustration, it is assumed in example 1200 that STAs 1204 and 1206 support IO data unit delivery as described above.

As shown in FIG. 12, the relaying procedure may begin by AP 1202 transmitting a frame 1210 to STA 1204. In an example, frame 1210 may be a PPDU comprising a unit 1211 and data units 1212-1, 1212-2, 1212-3 and 1212-4. Unit 1211 may comprise a PHY preamble and a PHY header (collectively denoted “P” in frame 1210). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 1200, data units 1212-1, 1212-2, 1212-3 and 1212-4 may comprise sequence numbers 1, 2, 3 and 4, respectively, as illustrated in FIG. 12. In an example, frame 1210 may further comprise a block ack request (BAR) (not shown in FIG. 12). When present, the BAR indicates that AP 1202 requests a block ack (BA) frame in response to frame 1210.

In an example, STA 1204 may receive frame 1210 transmitted by AP 1202. On receiving frame 1210, recipient STA 1204 may decode frame 1210, including decoding each of data units 1212-1, 1212-2, 1212-3, and 1212-4. A data unit that STA 1204 can decode successfully (e.g., for which an FCS check is successful) may be considered as received successfully by STA 1204. In contrast, a data unit that STA 1204 fails to decode successfully (e.g., for which an FCS check fails) may be considered as received in error by STA 1204. In example 1200, it is assumed data units 1212-1 (with sequence number 1), 1212-3 (with sequence number 3), and 1212-4 (with sequence number 4) are received successfully by recipient STA 1204 but that data unit 1212-2 (with sequence number 2) is received in error by recipient STA 1204. The MSDUs of data units that are received successfully by recipient STA 1204 are placed in the reorder buffer of STA 1204 according to their sequence numbers. The MSDUs of data units that are received in error by recipient STA 1204 are not placed in the reorder buffer and their corresponding locations in the reorder buffer are kept empty (e.g., creating one or more MSDU holes in the reorder buffer). As such, in example 1200, the reorder buffer of STA 1204 may comprise MSDUs of data units 1212-1, 1212-3, and 1212-4 associated with sequence numbers 1, 3 and 4. However, as data unit 1212-2 is received in error by recipient STA 1204, the reorder buffer may not include the MSDU of data unit 1212-2 (associated with sequence number 2), resulting in an MSDU hole in the reorder buffer. In another example, data units that are received successfully by the STA 1204, before a data unit received in error, are not placed in the reorder buffer and may be directly forwarded sequentially (e.g., according to their sequence numbers) to the STA 1206. As such, data units that are received successfully after the data unit received in error may be placed in the reorder buffer.

In an example, STA 1204 may transmit to AP 1202 a BA frame 1215 indicating that data unit 1212-2 was received in error by STA 1204. After transmitting BA frame 1215, STA 1204 may transmit to STA 1206 a frame 1220. Based on STA 1206 supporting IO delivery and data unit 1212-2 being received error, frame 1220 may comprise only the MSDU of data unit 1212-1 of frame 1210. For example, frame 1220 may be a PPDU comprising a unit 1221 and a data unit 1222. Unit 1221 may comprise a PHY preamble and a PHY header of frame 1220. Data unit 1222 may comprise the same MSDU of data unit 1212-1 of frame 1210. The MSDU of data unit 1222 may be associated with a same or a different sequence number as the MSDU of data unit 1212-1. Sequence numbers of MSDUs in a buffer may change with a same offset for all MSDUs in a sequence, if they are to be transmitted. As only the MSDU (or A-MSDU) of data unit 1212-1 is transmitted in frame 1220, STA 1204 may store MSDUs of data units 1212-3 and 1212-4 with sequence numbers 3 and 4, respectively, in its reorder buffer. STA 1204 may transmit the MSDUs of data units 1212-3 and 1212-4 only after receiving the MSDU of data unit 1212-2 with sequence number 2 successfully (MSDU with sequence number 2 will be received in a different data unit).

On receiving frame 1220, STA 1206 may decode frame 1220 and determine the units that are received successfully or received in error. In an example, unit 1221 and data unit 1222 (with sequence number 1) may be received successfully. In an example, supporting IO delivery, STA 1206 may forward the MSDU of data unit 1222 (with sequence number 1) in the reorder buffer to the higher layer. In an example, STA 1206 may transmit to STA 1204 BA frame 1225 indicating data unit 1222 was received successfully.

After receiving BA frame 1215 and during its allocated transmission period, AP 1202 may transmit to STA 1204 frame 1230. In an example, frame 1230 may be a PPDU comprising unit 1231, where unit 1231 comprises PHY preamble and PHY header, and data units 1232-2 and 1232-5. Data unit 1232-2 with sequence number 2 may comprise the same MSDU as the data unit 1212-2 with sequence number 2, and may be retransmitted in frame 1230. Data unit 1232-5 may comprise a new data unit comprising sequence number 5.

On receiving frame 1230, STA 1204 may decode frame 1230 and determine the units that are received successfully or received in error. In an example, unit 1231 and data units 1232-2 and 1232-5 (with sequence numbers 2 and 5, respectively) may be received successfully. In an example, STA 1204 may transmit to AP 1202 BA frame 1235 indicating data units 1232-2 and 1232-5 were received successfully. In an example, STA 1204 may place the MSDU with sequence number 2 (of data unit 1232-2) in the reorder buffer before earlier received MSDUs with sequence numbers 3 and 4. In addition, STA 1204 may place the MSDU with sequence number 5 (of data unit 1232-5) in the reorder buffer after earlier received MSDUs with sequence numbers 3 and 4.

In an example, after transmitting BA frame 1235 and based on the ability of STA 1206 to support IO delivery, STA 1204 may transmit to STA 1206 frame 1240. Frame 1240 may be a PPDU comprising unit 1241, where unit 1241 comprises PHY preamble and PHY header, and data units 1242-2, 1242-3, 1242-4 and 1242-5.

On receiving frame 1240, STA 1206 may decode frame 1240 and determine the units that are received successfully or received in error. In an example, unit 1241 and data units 1242-2, 1242-3, 1242-4 and 1242-5 (with sequence numbers 2, 3, 4 and 5, respectively) may be received successfully. In an example, supporting IO delivery, STA 1206 may forward the MSDUs of data units 1242-2, 1242-3, 1242-4 and 1242-5 (with sequence numbers 2, 3, 4 and 5, respectively) in the reorder buffer to the higher layer. In an example, STA 1206 may transmit to STA 1204 BA frame 1245 indicating data units 1242-2, 1242-3, 1242-4 and 1242-5 were received successfully.

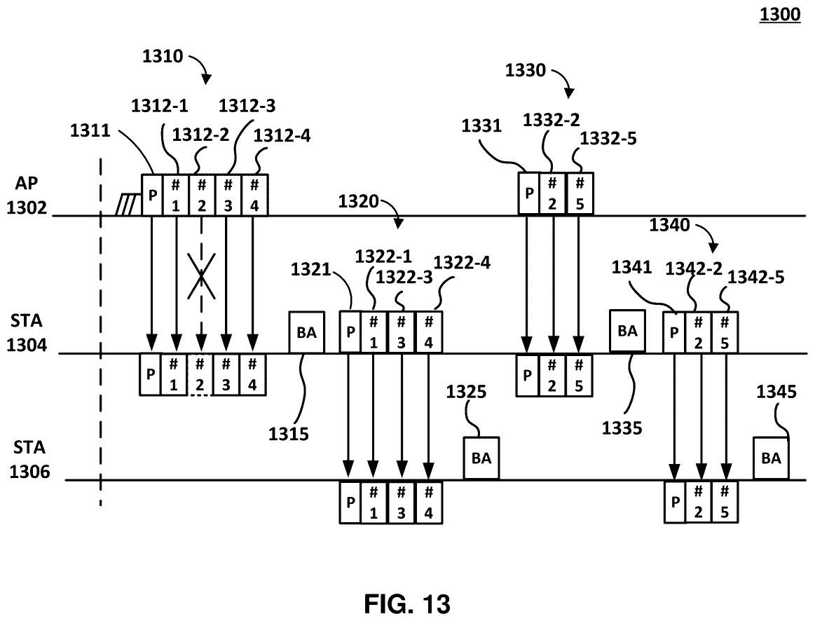

FIG. 13 illustrates another example 1300 of a relaying procedure, which may be used for relaying downlink traffic from an AP to a STA. As shown in FIG. 13, example 1300 may include an AP 1302 and a plurality of STAs 1304 and 1306. In an example, STAs 1304 and 1306 may be associated with AP 1302. In an example, AP 1302 and STAs 1304 and 1306 may be within each other's communication ranges. In an example, STA 1304 may receive data frames from AP 1302 destined to itself. In another example, STA 1304 may serve as a relay for STA 1306. For instance, AP 1302 may be configured to transmit a PPDU to STA 1306 via STA 1304 in order to increase the throughput of a downlink transmission. For the purpose of illustration, it is assumed in example 1300 that STAs 1304 and 1306 support OOO data unit delivery as described above.

As shown in FIG. 13, the relaying procedure may begin by AP 1302 transmitting a frame 1310 to STA 1304. In an example, frame 1310 may be a PPDU comprising a unit 1311 and data units 1312-1, 1312-2, 1312-3 and 1312-4. Unit 1311 may comprise a PHY preamble and a PHY header (collectively denoted “P” in frame 1310). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 1300, data units 1312-1, 1312-2, 1312-3 and 1312-4 may comprise sequence numbers 1, 2, 3 and 4, respectively, as illustrated in FIG. 13. In an example, frame 1310 may further comprise a block ack request (BAR) (not shown in FIG. 13). When present, the BAR indicates that AP 1302 requests a block ack (BA) frame in response to frame 1310.

In an example, STA 1304 may receive frame 1310 transmitted by AP 1302. On receiving frame 1310, recipient STA 1304 may decode frame 1310, including decoding each of data units 1312-1, 1312-2, 1312-3, and 1312-4. A data unit that STA 1304 can decode successfully (e.g., for which an FCS check is successful) may be considered as received successfully by STA 1304. In contrast, a data unit that recipient STA 1304 fails to decode successfully (e.g., for which an FCS check fails) may be considered as received in error by STA 1304. In example 1300, it is assumed data units 1312-1 (with sequence number 1), 1312-3 (with sequence number 3), and 1312-4 (with sequence number 4) are received successfully by STA 1304 but that data unit 1312-2 (with sequence number 2) is received in error by recipient STA 1304. The MSDUs of data units that are received successfully by recipient STA 1304 are placed in the reorder buffer of STA 1304 according to their sequence numbers. The MSDUs of data units that are received in error by recipient STA 1304 are not placed in the reorder buffer and their corresponding locations in the reorder buffer are kept empty (e.g., creating one or more MSDU holes in the reorder buffer). As such, in example 1300, the reorder buffer of STA 1304 may comprise MSDUs of data units 1312-1, 1312-3, and 1312-4 associated with sequence numbers 1, 3 and 4. However, as data unit 1312-2 is received in error by recipient STA 1304, the reorder buffer may not include the MSDU of data unit 1312-2 (associated with sequence number 2), resulting in an MSDU hole in the reorder buffer. In another example, data units that are received successfully by the STA 1304, before a data unit received in error, are not placed in the reorder buffer and may be directly forwarded sequentially (e.g., according to their sequence numbers) to the STA 1306.

In an example, STA 1304 may transmit to AP 1302 a BA frame 1315 indicating that data unit 1312-2 was received in error by STA 1304. After transmitting BA frame 1315, STA 1304 may transmit to STA 1306 a frame 1320. Based on STA 1306 supporting OOO delivery and data unit 1312-2 being received in error, frame 1320 may comprise all MSDUs of data units that were received correctly by STA 1304 excluding the MSDU of data unit 1312-2 of frame 1310 that was received in error. For example, frame 1320 may be a PPDU comprising a unit 1321 and data units 1322-1, 1322-3 and 1322-4. Unit 1321 may comprise a PHY preamble and a PHY header of frame 1320. Data units 1322-1, 1322-3 and 1322-4 may comprise the same MSDUs of data units 1312-1, 1312-3 and 1312-4 of frame 1310. The MSDUs of data units 1322-1, 1322-3 and 1322-4 may be associated with a same or a different sequence number as the MSDU of data units 1312-1, 1312-3 and 1312-4. Sequence numbers of MSDUs in a buffer may change with a same offset for all MSDUs in a sequence, if they are to be transmitted. In example 1300, frame 1320 comprises all the data units comprising MSDUs received successfully (despite data unit 1312-2 was received in error) since STA 1306 can support OOO delivery. Accordingly, STA 1304 may not need to store any MSDU of data units received successfully in its reorder buffer.

On receiving frame 1320, STA 1306 may decode frame 1320 and determine the units that are received successfully or received in error. In an example, unit 1321 and data units 1322-1, 1322-3 and 1322-4 (with sequence numbers 1, 3 and 4, respectively) may be received successfully. In an example, supporting OOO delivery, STA 1306 may forward the MSDUs of data units 1322-1, 1322-3 and 1322-4 (with sequence numbers 1, 3 and 4, respectively) in the reorder buffer to the higher layer. In an example, STA 1306 may transmit to STA 1304 BA frame 1325 indicating data units 1322-1, 1322-3 and 1322-4 were received successfully.

After receiving BA frame 1315 and during its allocated transmission period, AP 1302 may transmit to STA 1304 frame 1330. In an example, frame 1330 may be a PPDU comprising unit 1331, where unit 1331 comprises PHY preamble and PHY header, and data units 1332-2 and 1332-5. Data unit 1332-2 with sequence number 2 may comprise the same MSDU as the data unit 1312-2 with sequence number 2, and may be retransmitted in frame 1330. Data unit 1332-5 may comprise a new data unit comprising sequence number 5.

On receiving frame 1330, STA 1304 may decode frame 1330 and determine the units that are received successfully or received in error. In an example, unit 1331 and data units 1332-2 and 1332-5 (with sequence numbers 2 and 5, respectively) may be received successfully. In an example, STA 1304 may transmit to AP 1302 BA frame 1335 indicating data units 1332-2 and 1332-5 were received successfully. In an example, STA 1304 may place the MSDU with sequence number 2 (of data unit 1332-2) in the reorder buffer. In addition, STA 1304 may place the MSDU with sequence number 5 (of data unit 1332-5) in the reorder buffer after the MSDU with sequence number 2. In another example, data units that are received successfully by the STA 1304 are not placed in the reorder buffer and may be directly forwarded sequentially (e.g., according to their sequence numbers) to the STA 1306.

In an example, after transmitting BA frame 1335 and based on the ability of STA 1306 to support OOO delivery, STA 1304 may transmit to STA 1306 frame 1340. Frame 1340 may be a PPDU comprising unit 1341, where unit 1341 comprises PHY preamble and PHY header, and data units 1342-2 and 1342-5.

On receiving frame 1340, STA 1306 may decode frame 1340 and determine the units that are received successfully or received in error. In an example, unit 1341 and data units 1342-2 and 1342-5 (with sequence numbers 2 and 5, respectively) may be received successfully. In an example, supporting OOO delivery, STA 1306 may forward the MSDUs of data units 1342-2 and 1342-5 (with sequence numbers 2 and 5, respectively) in the reorder buffer to the higher layer. In an example, STA 1306 may transmit to STA 1304 BA frame 1345 indicating data units 1342-2 and 1342-5 were received successfully.

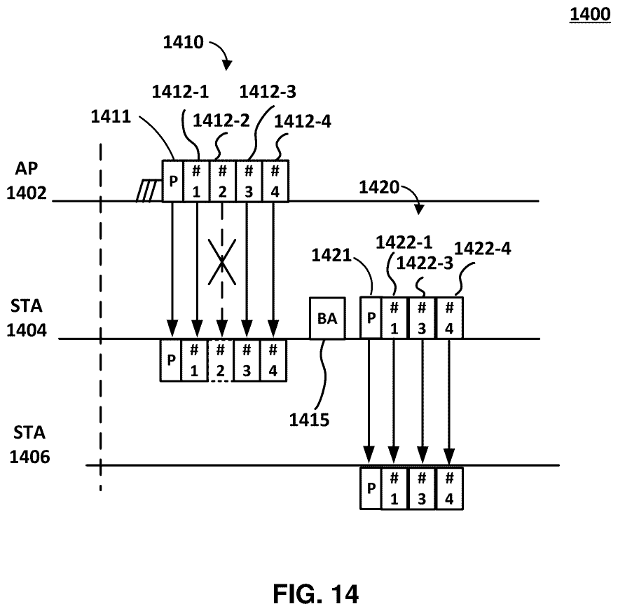

FIG. 14 illustrates another example 1400 of a relaying procedure, which may be used for relaying downlink traffic from an AP to a STA. As shown in FIG. 14, example 1400 may include an AP 1402 and a plurality of STAs 1404 and 1406. In an example, STAs 1404 and 1406 may be associated with AP 1402. In an example, AP 1402 and STAs 1404 and 1406 may be within each other's communication ranges. In an example, STA 1404 may receive data frames from AP 1402 destined to itself. In another example, STA 1404 may serve as a relay for STA 1406. For instance, AP 1402 may be configured to transmit a PPDU to STA 1406 via STA 1404 in order to increase the throughput of a downlink transmission. In an example, STA 1404 may support IO delivery and/or OOO delivery. In an example, STA 1406 may have capabilities that support IO delivery but not OOO delivery. For the purpose of illustration, in example 1400, it is assumed that STA 1404 may not have access to information corresponding to the capabilities of STA 1406, e.g., whether STA 1406 supports IO delivery and/or OOO delivery.

As shown in FIG. 14, the relaying procedure may begin by AP 1402 transmitting a frame 1410 to STA 1404. In an example, frame 1410 may be a PPDU comprising a unit 1411 and data units 1412-1, 1412-2, 1412-3 and 1412-4. Unit 1411 may comprise a PHY preamble and a PHY header (collectively denoted “P” in frame 1410). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 1400, data units 1412-1, 1412-2, 1412-3 and 1412-4 may comprise sequence numbers 1, 2, 3 and 4, respectively, as illustrated in FIG. 14. In an example, frame 1410 may further comprise a block ack request (BAR) (not shown in FIG. 14). When present, the BAR indicates that AP 1402 requests a block ack (BA) frame in response to frame 1410.

In an example, STA 1404 may receive frame 1410 transmitted by AP 1402. On receiving frame 1410, recipient STA 1404 may decode frame 1410, including decoding each of data units 1412-1, 1412-2, 1412-3, and 1412-4. A data unit that STA 1404 can decode successfully (e.g., for which an FCS check is successful) may be considered as received successfully by STA 1404. In contrast, a data unit that recipient STA 1404 fails to decode successfully (e.g., for which an FCS check fails) may be considered as received in error by STA 1404. In example 1400, it is assumed data units 1412-1 (with sequence number 1), 1412-3 (with sequence number 3), and 1412-4 (with sequence number 4) are received successfully by STA 1404 but that data unit 1412-2 (with sequence number 2) is received in error by recipient STA 1404. The MSDUs of data units that are received successfully by recipient STA 1404 are placed in the reorder buffer of STA 1404 according to their sequence numbers. The MSDUs of data units that are received in error by recipient STA 1404 are not placed in the reorder buffer and their corresponding locations in the reorder buffer are kept empty (e.g., creating one or more MSDU holes in the reorder buffer). As such, in example 1400, the reorder buffer of STA 1404 may comprise MSDUs of data units 1412-1, 1412-3, and 1412-4 associated with sequence numbers 1, 3 and 4. However, as data unit 1412-2 is received in error by recipient STA 1404, the reorder buffer may not include the MSDU of data unit 1412-2 (associated with sequence number 2), resulting in an MSDU hole in the reorder buffer. In another example, data units that are received successfully by the STA 1404, before a data unit received in error, are not placed in the reorder buffer and may be directly forwarded sequentially (e.g., according to their sequence numbers) to the STA 1406.

In an example, STA 1404 may transmit to AP 1402 BA frame 1415 indicating data unit 1412-2 was received in error. After transmitting BA frame 1415, notwithstanding that lack of information available to STA 1404 regarding whether STA 1406 has capabilities to handle OOO transmissions, STA 1404 may transmit to STA 1406 a frame to be handled by an OOO procedure. As such, STA 1404 may transmit data units out-of-order in terms of the sequence numbers of MSDUs. In an example, STA 1404 may be receiving some data units in error from AP 1402 and may want to remove the complete MPDUs from its reorder buffer by transmitting them out-of-order to STA 1406. In another example, despite a data unit may be received in error by STA 1404 from AP 1402, STA 1404 may receive a new data unit with a higher priority, and with a higher sequence number, from AP 1402. Hence, STA 1404 may prefer to transmit data units out-of-order for low latency transmission.

In example 1400, after transmitting BA frame 1415, STA 1404 may transmit to STA 1406 frame 1420. In an example, frame 1420 may be a PPDU comprising unit 1421, where unit 1421 comprises PHY preamble and PHY header, and data units 1422-1, 1422-3 and 1422-4. For the depiction of this example in FIG. 14, the MSDUs of data units 1422-1, 1422-3 and 1422-4 transmitted to STA 1406 from STA 1404, respectively correspond to the MSDUs of data units 1412-1, 1412-3 and 1412-4, successfully received by STA 1404 from AP 1402. In example 1400, frame 1420 comprises all the data units comprising MSDUs received successfully (despite data unit 1412-2 being received in error).

On receiving frame 1420, STA 1406 may decode frame 1420 and determine the units that are received successfully or received in error. In an example, unit 1421 and data units 1422-1, 1422-3 and 1422-4 (with sequence numbers 1, 3 and 4, respectively) may be received successfully. In an example, STA 1406 may not support OOO delivery. As such, STA 1406 may only forward the MSDU of data unit 1422-1 (with sequence number 1) to the higher layer, and keep the MSDUs of data units 1422-3 and 1422-4 (with sequence numbers 3 and 4, respectively) in the reorder buffer. Accordingly, data units further to be received by STA 1406 may also increase the number of MSDUs in the reorder buffer that are not forwarded to the higher layer timely. As such, because STA 1404 cannot use the delivery capabilities of STA 1406 to support STA 1406, STA 1404 may not be able to assist STA 1406 with different processes associated with receipt of data units 1422-1, 1422-3 and 1422-4, e.g., processes associated with the coordination of the transmission of MSDUs in the reorder buffer of STA 1406 to the higher layer efficiently.

Embodiments of the present disclosure, as further described below, address the above-described problem. In one aspect, a first STA (e.g., relay STA) may receive from a second STA (e.g., AP) one or more frames comprising a first data unit and a second data unit, following the first data unit, for transmission by the first STA to a third STA (e.g., destination STA); and an indication of whether transmission of the second data unit before the first data unit is allowed. The first STA may transmit to the third STA, a second frame comprising one or more of the first and the second data units, based on the indication. In an embodiment, the indication may comprise a first indication that transmission of the second data unit before the first data unit is to be performed when the first data unit is received in error. In an embodiment, where the first data unit is received in error and the second frame comprises the second data unit, the second frame may not comprise the first data unit. In another embodiment, the indication may further comprise a second indication that transmission of the second data unit before the first data unit is not to be performed. In an embodiment, where the first data unit is received in error, the second frame may comprise the first data unit. In an embodiment, the indication may be based on the data unit delivery capabilities (e.g., IO and/or OOO delivery) of the third STA. Accordingly, the second STA may instruct or control the first STA to forward data units to the third STA depending on the data unit delivery capabilities of the third STA, enhancing the forwarding of MSDUs to the higher layers at the third STA. In another embodiment, the indication may be further based on traffic conditions. For example, considering the data unit delivery capabilities of the third STA, the second STA may instruct or control the first STA to forward data units to the third STA using IO or OOO delivery to ensure faster delivery of higher priority (e.g., low latency) data units to the third STA and/or to lower reorder buffer congestion at the first STA.

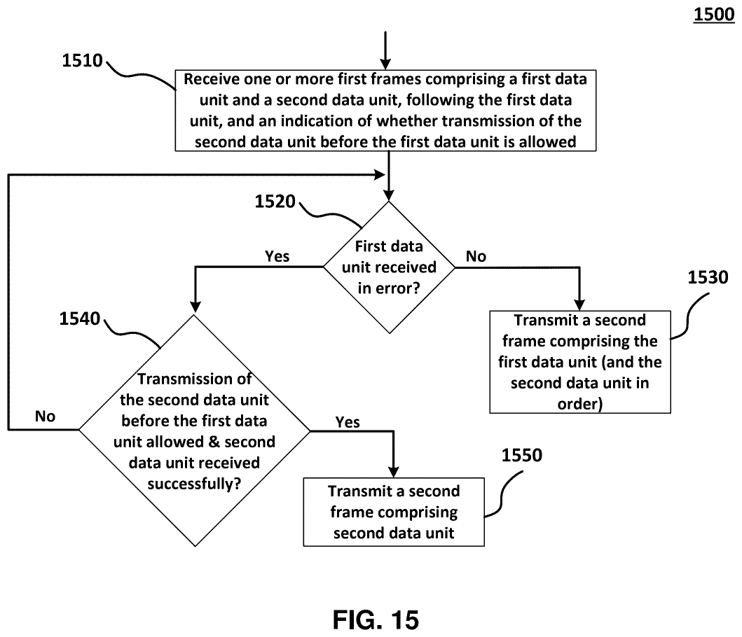

FIG. 15 illustrates an example process 1500 according to an embodiment. Example process 1500 is provided for the purpose of illustration only and is not limiting of embodiments. Example process 1500 may be performed by a first STA. In an example, the first may be a relay STA.

As shown in FIG. 15, process 1500 may start in step 1510, which includes receiving one or more first frames from a second STA. The second STA may be an AP with which the first STA is associated. In an embodiment, the one or more first frames may comprise a first data unit and a second data unit, following the first data unit, for transmission by the first STA to a third STA. In an example, the third STA may be a destination STA. The one or more frames may further comprise an indication of whether transmission of the second data unit before the first data unit is allowed.

Next, process 1500 proceeds to step 1520, which includes determining whether the first data unit is received in error. In an embodiment, the first data unit may be an MPDU comprising a MAC header, an MSDU or an A-MSDU, and an FCS field. In an embodiment, step 1520 may include checking the FCS field of the first data unit to determine whether the first data unit is received in error.

If the answer is no in step 1520 (i.e., the first data unit is not received in error), process 1500 proceeds to step 1530, in which the first STA transmits to the third STA a second frame comprising the first data unit. In an embodiment, assuming the second data unit is also not received in error, the second frame may further comprise the second data unit.

If the answer is yes in step 1520 (i.e., the first data unit is received in error), process 1500 proceeds to step 1540, in which the first STA determines whether transmission of the second data unit before the first data unit is allowed and whether the second data unit is received successfully. In an embodiment, the first STA may check the indication received in the one or more frames to determine whether transmission of the second data unit before the first data unit is allowed. In an embodiment, the indication may comprise a first indication that transmission of the second data unit before the first data unit is to be performed when the first data unit is received in error (and the second data unit is received successfully). In another embodiment, the indication may further comprise a second indication that transmission of the second data unit before the first data unit is not to be performed (even when the first data unit is received in error and the second data unit is received successfully).

If the answer is no in step 1540 (i.e., transmission of the second data unit before the first data unit is not allowed or the second data unit is not received successfully), process 1500 proceeds to back to step 1520, in which the first STA determines whether the first data unit (received in a subsequent frame from the second STA) is received in error.

If the answer is yes in step 1540 (i.e., transmission of the second data unit before the first data unit is allowed and the second data unit is received successfully), process 1500 proceeds to step 1550, in which the first STA transmits a second frame comprising the second data unit. In an embodiment, before transmitting the second frame, the first STA may transmit to the second STA, a third frame indicating the first data unit was received in error by the first STA. In an embodiment, the third frame may comprise a block acknowledgment (BA) frame. In an embodiment, before transmitting the second frame and in response to the third frame, the first STA may receive from the second STA, a fourth frame comprising the first data unit.

Process 1500 may further comprise the steps, after step 1550, in which the first STA may transmit to the second STA, a third frame indicating the first data unit was received in error by the first STA. In an embodiment, the third frame may comprise a block acknowledgment (BA) frame. In an embodiment, the first STA may receive from the second STA, a fourth frame comprising the first data unit in response to the third frame. In an embodiment, first STA may transmit to the third STA, a fifth frame comprising the first data unit.

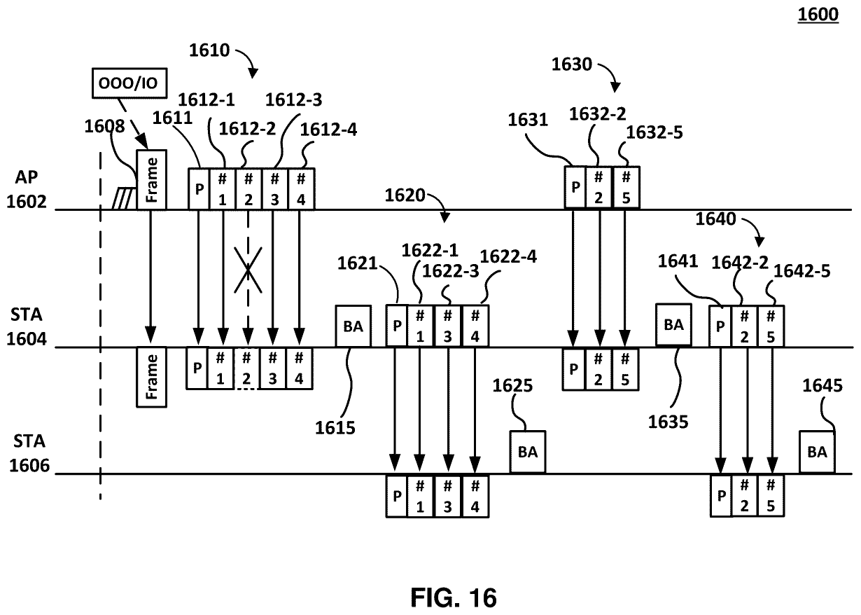

FIG. 16 illustrates an example 1600 of a relaying procedure, which may be used for relaying downlink traffic from an AP to a STA, according to an embodiment. As shown in FIG. 16, example 1600 may include an AP 1602 and a plurality of STAs 1604 and 1606. In an example, STAs 1604 and 1606 may be associated with AP 1602. In an example, AP 1602 and STAs 1604 and 1606 may be within each other's communication ranges. In an example, STA 1604 may receive data frames from AP 1602 destined to itself. In another example, STA 1604 may serve as a relay for STA 1606. For instance, AP 1602 may be configured to transmit a PPDU to STA 1606 via STA 1604 in order to increase the throughput of a downlink transmission. In an example, STAs 1604 and 1606 may support IO delivery and/or OOO delivery. For the purpose of illustration, in example 1600, it is assumed that STA 1604 may not have access to information corresponding to the capabilities of STA 1606, e.g., whether STA 1606 supports IO delivery and/or OOO delivery. In example 1600, it is assumed that AP 1602 may have access to information corresponding to the capabilities of STA 1606, e.g., whether STA 1606 supports IO delivery and/or OOO delivery.

As shown in FIG. 16, the relaying procedure of example 1600 may begin by AP 1602 transmitting frame 1608 to STA 1604. In an embodiment, frame 1608 may comprise an indication of whether transmission of a second data unit before a first data unit, where the second data unit follows the first data unit, is allowed. In an embodiment, AP 1602 may be configured to provide an indication to STA 1604 as to whether STA 1606 supports IO delivery and/or OOO delivery. In another example, AP 1602 may instruct or control STA 1604 whether to perform transmission of a second data unit before a first data unit, when the first data unit is received in error.

In an embodiment, AP 1602 may determine whether OOO transmission of data units is indicated for example 1600 based on the data unit delivery capabilities of STA 1606 (e.g., supporting IO delivery and/or OOO delivery). In an example, AP 1602 may obtain the data unit delivery capabilities of STA 1606 directly from STA 1606. In another example, AP 1602 may determine whether OOO transmission of data units is indicated for example 1600 based on the necessity for a faster delivery of higher priority (e.g., low latency) data units to STA 1606 and/or to lower reorder buffer congestion at STA 1604, considering the data unit delivery capabilities of STA 1606, during a relay operation.

In example 1600, AP 1602 may transmit frame 1608 to STA 1604 before transmitting data units to be forwarded to STA 1606. In an embodiment, frame 1608 may comprise a management frame. In an embodiment, the management frame may comprise an action frame. In an embodiment, the indication may comprise a first indication that transmission of the second data unit before the first data unit is to be performed when the first data unit is received in error.

In an example, STA 1604 may receive frame 1608 transmitted by AP 1602. Based on the indication in frame 1608, STA 1604 may determine that AP 1602 instructs or controls STA 1604 to transmit a second data unit before a first data unit, if the first data unit is received in error. In an example, STA 1604 considers the indication for all data units to be transmitted to STA 1606.

In example 1600, after transmitting frame 1608, AP 1602 may transmit frame 1610. In an example, frame 1610 may be a PPDU comprising a unit 1611 and data units 1612-1, 1612-2, 1612-3 and 1612-4. Unit 1611 may comprise a PHY preamble and a PHY header (collectively denoted “P” in frame 1610). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 1600, data units 1612-1, 1612-2, 1612-3 and 1612-4 may comprise sequence numbers 1, 2, 3 and 4, respectively, as illustrated in FIG. 16. In an example, frame 1610 may further comprise a block ack request (BAR) (not shown in FIG. 16). When present, the BAR indicates that AP 1602 requests a block ack (BA) frame in response to frame 1610.

In an example, STA 1604 may receive frame 1610 transmitted by AP 1602. On receiving frame 1610, STA 1604 may decode frame 1610, including decoding each of data units 1612-1, 1612-2, 1612-3, and 1612-4. A data unit that STA 1604 can decode successfully (e.g., for which an FCS check is successful) may be considered as received successfully by STA 1604. In contrast, a data unit that STA 1604 fails to decode successfully (e.g., for which an FCS check fails) may be considered as received in error by STA 1604. In example 1600, it is assumed data units 1612-1 (with sequence number 1), 1612-3 (with sequence number 3), and 1612-4 (with sequence number 4) are received successfully by STA 1604 but that data unit 1612-2 (with sequence number 2) is received in error by recipient STA 1604. The MSDUs of data units that are received successfully by recipient STA 1604 are placed in the reorder buffer of STA 1604 according to their sequence numbers. The MSDUs of data units that are received in error by recipient STA 1604 are not placed in the reorder buffer and their corresponding locations in the reorder buffer are kept empty (e.g., creating one or more MSDU holes in the reorder buffer). As such, in example 1600, the reorder buffer of STA 1604 may comprise MSDUs of data units 1612-1, 1612-3, and 1612-4 associated with sequence numbers 1, 3 and 4. However, as data unit 1612-2 is received in error by recipient STA 1604, the reorder buffer may not include the MSDU of data unit 1612-2 (associated with sequence number 2), resulting in an MSDU hole in the reorder buffer. In another example, data units that are received successfully by the STA 1604, before a data unit received in error, are not placed in the reorder buffer and may be directly forwarded sequentially (e.g., according to their sequence numbers) to the STA 1606.

In an example, STA 1604 may transmit to AP 1602 a BA frame 1615 indicating that data unit 1612-2 was received in error by STA 1604. After transmitting BA frame 1615, STA 1604 may transmit to STA 1606 a frame 1620. Based STA 1606 supporting OOO delivery (indicated in frame 1608) and data unit 1612-2 being received in error, frame 1620 may comprise all MSDUs of data units that were received correctly by STA 1604 excluding the MSDU of data unit 1612-2 of frame 1610 that was received in error. For example, frame 1620 may be a PPDU comprising a unit 1621 and data units 1622-1, 1622-3 and 1622-4. Unit 1621 may comprise a PHY preamble and a PHY header of frame 1620. Data units 1622-1, 1622-3 and 1622-4 may comprise the same MSDUs of data units 1612-1, 1612-3 and 1612-4 of frame 1610. The MSDUs of data units 1622-1, 1622-3 and 1622-4 may be associated with a same or a different sequence number as the MSDU of data units 1612-1, 1612-3 and 1612-4. Sequence numbers of MSDUs in a buffer may change with a same offset for all MSDUs in a sequence, if they are to be transmitted. In example 1600, frame 1620 comprises all the data units comprising MSDUs received successfully (despite data unit 1612-2 was received in error) since STA 1606 can support OOO delivery. Accordingly, STA 1604 may not need to store any MSDU of data units received successfully in its reorder buffer.

On receiving frame 1620, STA 1606 may decode frame 1620 and determine the units that are received successfully or received in error. In an example, unit 1621 and data units 1622-1, 1622-3 and 1622-4 (with sequence numbers 1, 3 and 4, respectively) may be received successfully. In an example, supporting OOO delivery, STA 1606 may forward the MSDUs of data units 1622-1, 1622-3 and 1622-4 (with sequence numbers 1, 3 and 4, respectively) in the reorder buffer to the higher layer. In an example, STA 1606 may transmit to STA 1604 BA frame 1625 indicating data units 1622-1, 1622-3 and 1622-4 were received successfully.

After receiving BA frame 1615 and during its allocated transmission period, AP 1602 may transmit to STA 1604 frame 1630. In an example, frame 1630 may be a PPDU comprising unit 1631, where unit 1631 comprises PHY preamble and PHY header, and data units 1632-2 and 1632-5. Data unit 1632-2 with sequence number 2 may comprise the same MSDU as the data unit 1612-2 with sequence number 2, and may be retransmitted in frame 1630. Data unit 1632-5 may comprise a new data unit comprising sequence number 5.

On receiving frame 1630, STA 1604 may decode frame 1630 and determine the units that are received successfully or received in error. In an example, unit 1631 and data units 1632-2 and 1632-5 (with sequence numbers 2 and 5, respectively) may be received successfully. In an example, STA 1604 may transmit to AP 1602 BA frame 1635 indicating data units 1632-2 and 1632-5 were received successfully. In an example, STA 1604 may place the MSDU with sequence number 2 (of data unit 1632-2) in the reorder buffer. In addition, STA 1604 may place the MSDU with sequence number 5 (of data unit 1632-5) in the reorder buffer after the MSDU with sequence number 2. In another example, data units that are received successfully by the relay STA are not placed in the reorder buffer and may be directly forwarded sequentially (e.g., according to their sequence numbers) to the destination STA.

In an example, after transmitting BA frame 1635 and based on the ability of STA 1606 to support OOO delivery, STA 1604 may transmit to STA 1606 frame 1640. Frame 1640 may be a PPDU comprising unit 1641 and data units 1642-2 and 1642-5. Unit 1641 may comprise a PHY preamble and a PHY header. Data units 1642-2 and 1642-5 may comprise the same MSDUs of data units 1632-2 and 1632-5.

On receiving frame 1640, STA 1606 may decode frame 1640 and determine the units that are received successfully or received in error. In an example, unit 1641 and data units 1642-2 and 1642-5 (with sequence numbers 2 and 5, respectively) may be received successfully. In an example, supporting OOO delivery, STA 1606 may forward the MSDUs of data units 1642-2 and 1642-5 (with sequence numbers 2 and 5, respectively) in the reorder buffer to the higher layer. In an example, STA 1606 may transmit to STA 1604 BA frame 1645 indicating data units 1642-2 and 1642-5 were received successfully. As illustrated in example 1600, since AP 1602 has instructed STA 1604 of how to transmit data units to STA 1606, the transmission of MSDUs to the higher layer at STA 1606 has been more efficient.

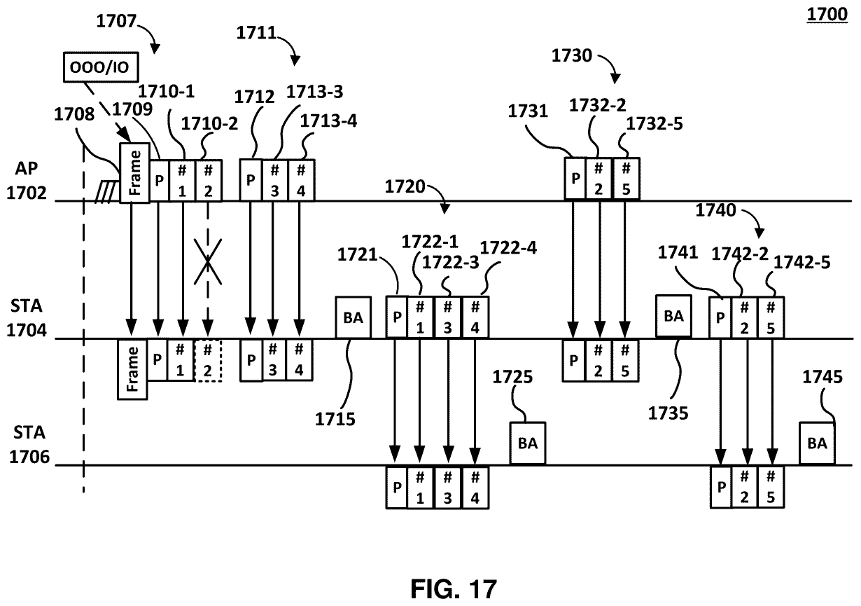

FIG. 17 illustrates another example 1700 of a relaying procedure, which may be used for relaying downlink traffic from an AP to a STA, according to an embodiment. As shown in FIG. 17, example 1700 may include an AP 1702 and a plurality of STAs 1704 and 1706. In an example, STAs 1704 and 1706 may be associated with AP 1702. In an example, AP 1702 and STAs 1704 and 1706 may be within each other's communication ranges. In an example, STA 1704 may receive data frames from AP 1702 destined to itself. In another example, STA 1704 may serve as a relay for STA 1706. For instance, AP 1702 may be configured to transmit a PPDU to STA 1706 via STA 1704 in order to increase the throughput of a downlink transmission. In an example, STAs 1704 and 1706 may support IO delivery and/or OOO delivery. For the purpose of illustration, in example 1700, it is assumed that STA 1704 may not have access to information corresponding to the capabilities of STA 1706, e.g., whether STA 1706 supports IO delivery and/or OOO delivery. In example 1700, it is assumed that AP 1702 may have access to information corresponding to the capabilities of STA 1706, e.g., whether STA 1706 supports IO delivery and/or OOO delivery.

As shown in FIG. 17, the relaying procedure may begin by AP 1702 transmitting frame 1707 to STA 1704. In an example, frame 1707 may comprise frame 1708 and a PPDU, aggregated to frame 1708, comprising unit 1709 and data units 1710-1 and 1710-2.

In an embodiment, frame 1708 may comprise an indication of whether transmission of a second data unit before a first data unit, where the second data unit follows the first data unit, is allowed. In an embodiment, AP 1702 may be configured to provide an indication to STA 1704 as to whether STA 1706 supports IO delivery and/or OOO delivery. In another example, AP 1702 may instruct or control STA 1704 whether to perform transmission of a second data unit before a first data unit, when the first data unit is received in error. In an embodiment, AP 1702 may determine whether OOO transmission of data units is indicated for example 1700 based on the data unit delivery capabilities of STA 1706 (e.g., supporting IO delivery and/or OOO delivery). In an example, AP 1702 may obtain the data unit delivery capabilities of STA 1706 directly from STA 1706. In another example, AP 1702 may determine whether OOO transmission of data units is indicated for example 1700 based on the necessity for a faster delivery of higher priority (e.g., low latency) data units to STA 1706 and/or to lower reorder buffer congestion at STA 1704, considering the data unit delivery capabilities of STA 1706, during a relay operation.

In example 1700, AP 1702 may transmit frame 1708 to STA 1704 within frame 1707, aggregated to one or more data units to be forwarded to STA 1706. In an embodiment, frame 1708 may comprise a management frame. In an embodiment, the management frame may comprise an action frame. In an embodiment, the indication may comprise a first indication that transmission of the second data unit before the first data unit is to be performed when the first data unit is received in error.

In example 1700, AP 1702 may transmit one or more data units aggregated to frame 1708, within frame 1707. In an example, frame 1707 may be a PPDU comprising unit 1709 and data units 1710-1 and 1710-2. Unit 1709 may comprise a PHY preamble and a PHY header (collectively denoted “P” in frame 1707). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 1710-1 and 1710-2 may comprise sequence numbers 1 and 2, respectively, as illustrated in FIG. 17. In an example, frame 1707 may further comprise a block ack request (BAR) (not shown in FIG. 17). When present, the BAR indicates that AP 1702 requests a block ack (BA) frame in response to frame 1707. In another example, frame 1707 may not comprise a BAR.

In an example, STA 1704 may receive frame 1707 transmitted by AP 1702. Based on the indication in frame 1708, comprised in frame 1707, STA 1704 may determine that AP 1702 instructs or controls STA 1704 to transmit a second data unit before a first data unit, if the first data unit is received in error. In an example, STA 1704 considers the indication for all data units to be transmitted to STA 1706. By decoding the rest of frame 1707, STA 1704 may determine the units that are received successfully or received in error, including each of data units 1710-1 and 1710-2. A data unit that STA 1704 can decode successfully (e.g., for which an FCS check is successful) may be considered as received successfully by STA 1704. In contrast, a data unit that STA 1704 fails to decode successfully (e.g., for which an FCS check fails) may be considered as received in error by STA 1704. In example 1700, it is assumed data units 1710-1 (with sequence number 1) is received successfully by STA 1704 but that data unit 1710-2 (with sequence number 2) is received in error by STA 1704. The MSDUs of data units that are received successfully by recipient STA 1704 are placed in the reorder buffer of STA 1704 according to their sequence numbers. The MSDUs of data units that are received in error by recipient STA 1704 are not placed in the reorder buffer and their corresponding locations in the reorder buffer are kept empty (e.g., creating one or more MSDU holes in the reorder buffer). As such, in example 1700, the reorder buffer of STA 1704 may comprise the MSDU of data unit 1710-1 associated with sequence number 1. However, as data unit 1710-2 is received in error by recipient STA 1704, the reorder buffer may not include the MSDU of data unit 1710-2 (associated with sequence number 2), resulting in an MSDU hole in the reorder buffer. In another example, data units that are received successfully by the STA 1704, before a data unit received in error, are not placed in the reorder buffer and may be directly forwarded sequentially (e.g., according to their sequence numbers) to the STA 1706.

In example 1700, after transmitting frame 1707, AP 1702 may transmit frame 1711 to STA 1704. In an example, frame 1711 may be a PPDU comprising unit 1712 and data units 1713-3 and 1713-4. Unit 1712 may comprise a PHY preamble and a PHY header (collectively denoted “P” in the illustrated frame for unit 1712). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 1713-3 and 1713-4 may comprise sequence numbers 3 and 4, respectively, as illustrated in FIG. 17. In an example, frame 1711 may further comprise a block ack request (BAR) (not shown in FIG. 17). When present, the BAR indicates that AP 1702 requests a block ack (BA) frame in response to frame 1711.

In an example, STA 1704 may receive frame 1711 transmitted by AP 1702. By decoding frame 1711, STA 1704 may determine the units that are received successfully or received in error. In an example, unit 1712 and data units 1713-3 (with sequence number 3) and 1713-4 (with sequence number 4) may be received successfully. The MSDUs of data units that are received successfully are placed in the reorder buffer according to their sequence numbers. In example 1700, the reorder buffer of STA 1704 may comprise MSDUs of data units 1710-1, 1713-3, and 1713-4 associated with sequence numbers 1, 3 and 4. However, as data unit 1710-2 is received in error by recipient STA 1704, the reorder buffer may not include the MSDU of data unit 1710-2 (associated with sequence number 2), resulting in an MSDU hole in the reorder buffer. In another example, data units that are received successfully by the STA 1704, before a data unit received in error, are not placed in the reorder buffer and may be directly forwarded sequentially (e.g., according to their sequence numbers) to the STA 1706. In an embodiment, AP 1702 may have requested STA 1704 forward data units that are received successfully after STA 1704 has received frame 1711.

In an example, STA 1704 may transmit to AP 1702 a BA frame 1715 indicating that data unit 1710-2 was received in error by STA 1704. After transmitting BA frame 1715, STA 1704 may transmit to STA 1706 a frame 1720. Based STA 1706 supporting OOO delivery (indicated in frame 1708) and data unit 1710-2 being received in error, frame 1720 may comprise all MSDUs of data units that were received correctly by STA 1704 excluding the MSDU of data unit 1710-2 of frame 1707 that was received in error. For example, frame 1720 may be a PPDU comprising a unit 1721 and data units 1722-1, 1722-3 and 1722-4. Unit 1721 may comprise a PHY preamble and a PHY header of frame 1720. Data units 1722-1, 1722-3 and 1722-4 may comprise the same MSDUs of data unit 1710-1 of frame 1707 and data units 1713-3 and 1713-4 of frame 1711. The MSDUs of data units 1722-1, 1722-3 and 1722-4 may be associated with a same or a different sequence number as the MSDU of data units 1710-1, 1713-3 and 1713-4. Sequence numbers of MSDUs in a buffer may change with a same offset for all MSDUs in a sequence, if they are to be transmitted. In example 1700, frame 1720 comprises all the data units comprising MSDUs received successfully (despite data unit 1710-2 was received in error) since STA 1706 can support OOO delivery. Accordingly, STA 1704 may not need to store any MSDU of data units received successfully in its reorder buffer.

On receiving frame 1720, STA 1706 may decode frame 1720 and determine the units that are received successfully or received in error. In an example, unit 1721 and data units 1722-1, 1722-3 and 1722-4 (with sequence numbers 1, 3 and 4, respectively) may be received successfully. In an example, supporting OOO delivery, STA 1706 may forward the MSDUs of data units 1722-1, 1722-3 and 1722-4 (with sequence numbers 1, 3 and 4, respectively) in the reorder buffer to the higher layer. In an example, STA 1706 may transmit to STA 1704 BA frame 1725 indicating data units 1722-1, 1722-3 and 1722-4 were received successfully.

After receiving BA frame 1715 and during its allocated transmission period, AP 1702 may transmit to STA 1704 frame 1730. In an example, frame 1730 may be a PPDU comprising unit 1731, where unit 1731 comprises PHY preamble and PHY header, and data units 1732-2 and 1732-5. Data unit 1732-2 with sequence number 2 may comprise the same MSDU as the data unit 1710-2 with sequence number 2, and may be retransmitted in frame 1730. Data unit 1732-5 may comprise a new data unit comprising sequence number 5.

On receiving frame 1730, STA 1704 may decode frame 1730 and determine the units that are received successfully or received in error. In an example, unit 1731 and data units 1732-2 and 1732-5 (with sequence numbers 2 and 5, respectively) may be received successfully. In an example, STA 1704 may transmit to AP 1702 BA frame 1735 indicating data units 1732-2 and 1732-5 were received successfully. In an example, STA 1704 may place the MSDU with sequence number 2 (of data unit 1732-2) in the reorder buffer. In addition, STA 1704 may place the MSDU with sequence number 5 (of data unit 1732-5) in the reorder buffer after the MSDU with sequence number 2. In another example, data units that are received successfully by the relay STA are not placed in the reorder buffer and may be directly forwarded sequentially (e.g., according to their sequence numbers) to the destination STA.

In an example, after transmitting BA frame 1735 and based on the ability of STA 1706 to support OOO delivery, STA 1704 may transmit to STA 1706 frame 1740. Frame 1740 may be a PPDU comprising unit 1741 and data units 1742-2 and 1742-5. Unit 1741 may comprise a PHY preamble and a PHY header. Data units 1742-2 and 1742-5 may comprise the same MSDUs of data units 1732-2 and 1732-5.

On receiving frame 1740, STA 1706 may decode frame 1740 and determine the units that are received successfully or received in error. In an example, unit 1741 and data units 1742-2 and 1742-5 (with sequence numbers 2 and 5, respectively) may be received successfully. In an example, supporting OOO delivery, STA 1706 may forward the MSDUs of data units 1742-2 and 1742-5 (with sequence numbers 2 and 5, respectively) in the reorder buffer to the higher layer. In an example, STA 1706 may transmit to STA 1704 BA frame 1745 indicating data units 1742-2 and 1742-5 were received successfully. As illustrated in example 1700, since AP 1702 has instructed STA 1704 of how to transmit data units to STA 1706, the transmission of MSDUs to the higher layer at STA 1706 has been more efficient.

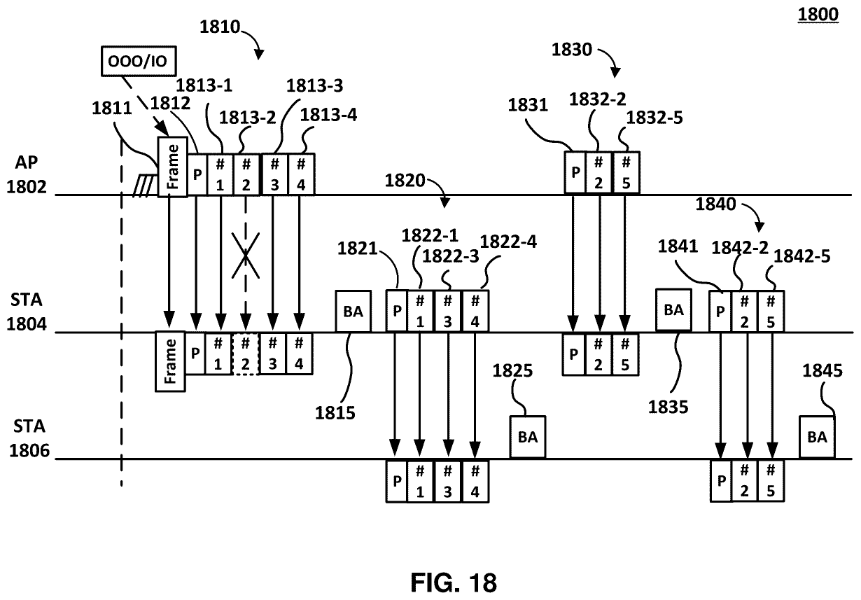

FIG. 18 illustrates another example 1800 of a relaying procedure, which may be used for relaying downlink traffic from an AP to a STA, according to an embodiment. As shown in FIG. 18, example 1800 may include an AP 1802 and a plurality of STAs 1804 and 1806. In an example, STAs 1804 and 1806 may be associated with AP 1802. In an example, AP 1802 and STAs 1804 and 1806 may be within each other's communication ranges. In an example, STA 1804 may receive data frames from AP 1802 destined to itself. In another example, STA 1804 may serve as a relay for STA 1806. For instance, AP 1802 may be configured to transmit a PPDU to STA 1806 via STA 1804 in order to increase the throughput of a downlink transmission. In an example, STAs 1804 and 1806 may support IO delivery and/or OOO delivery. For the purpose of illustration, in example 1800, it is assumed that STA 1804 may not have access to information corresponding to the capabilities of STA 1806, e.g., whether STA 1806 supports IO delivery and/or OOO delivery. In example 1800, it is assumed that AP 1802 may have access to information corresponding to the capabilities of STA 1806, e.g., whether STA 1806 supports IO delivery and/or OOO delivery.

As shown in FIG. 18, the relaying procedure may begin by AP 1802 transmitting frame 1810 to STA 1804. In an example, frame 1810 may comprise frame 1811 and a PPDU, aggregated to frame 1811, comprising unit 1812 and data units 1813-1, 1813-2, 1813-3 and 1813-4.

In an embodiment, frame 1811 may comprise an indication of whether transmission of a second data unit before a first data unit, where the second data unit follows the first data unit, is allowed. In an embodiment, AP 1802 may be configured to provide an indication to STA 1804 as to whether STA 1806 supports IO delivery and/or OOO delivery. In another example, AP 1802 may instruct or control STA 1804 whether to perform transmission of a second data unit before a first data unit, when the first data unit is received in error. In an embodiment, AP 1802 may determine whether OOO transmission of data units is indicated for example 1800 based on the data unit delivery capabilities of STA 1806 (e.g., supporting IO delivery and/or OOO delivery). In an example, AP 1802 may obtain the data unit delivery capabilities of STA 1806 directly from STA 1806. In another example, AP 1802 may determine whether OOO transmission of data units is indicated for example 1800 based on the necessity for a faster delivery of higher priority (e.g., low latency) data units to STA 1806 and/or to lower reorder buffer congestion at STA 1804, considering the data unit delivery capabilities of STA 1806, during a relay operation.

In example 1800, AP 1802 may transmit frame 1811 to STA 1804 within frame 1810, aggregated to one or more data units to be forwarded to STA 1806. In an embodiment, frame 1811 may comprise a management frame. In an embodiment, the management frame may comprise an action frame. In an embodiment, the indication may comprise a first indication that transmission of the second data unit before the first data unit is to be performed when the first data unit is received in error.

In example 1800, AP 1802 may transmit one or more data units aggregated to frame 1811, within frame 1810. In an example, frame 1810 may be a PPDU comprising unit 1812 and data units 1813-1, 1813-2, 1813-3 and 1813-4. Unit 1812 may comprise a PHY preamble and a PHY header (collectively denoted “P” in frame 1810). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 1813-1, 1813-2, 1813-3 and 1813-4 may comprise sequence numbers 1, 2, 3 and 4, respectively, as illustrated in FIG. 18. In an example, frame 1810 may further comprise a block ack request (BAR) (not shown in FIG. 18). When present, the BAR indicates that AP 1802 requests a block ack (BA) frame in response to frame 1810.

In an example, STA 1804 may receive frame 1810 transmitted by AP 1802. Based on the indication in frame 1811, comprised in frame 1810, STA 1804 may determine that AP 1802 instructs or controls STA 1804 to transmit a second data unit before a first data unit, if the first data unit is received in error. In an example, STA 1804 considers the indication for all data units to be transmitted to STA 1806. By decoding the rest of frame 1810, STA 1804 may determine the units that are received successfully or received in error, including each of data units 1813-1, 1813-2, 1813-3 and 1813-4. A data unit that STA 1804 can decode successfully (e.g., for which an FCS check is successful) may be considered as received successfully by STA 1804. In contrast, a data unit that STA 1804 fails to decode successfully (e.g., for which an FCS check fails) may be considered as received in error by STA 1804. In example 1800, it is assumed data units 1813-1 (with sequence number 1), 1813-3 (with sequence number 3) and 1813-4 (with sequence number 4) are received successfully by STA 1804 but that data unit 1813-2 (with sequence number 2) is received in error by STA 1804. The MSDUs of data units that are received successfully by recipient STA 1804 are placed in the reorder buffer of STA 1804 according to their sequence numbers. The MSDUs of data units that are received in error by recipient STA 1804 are not placed in the reorder buffer and their corresponding locations in the reorder buffer are kept empty (e.g., creating one or more MSDU holes in the reorder buffer). As such, in example 1800, the reorder buffer of STA 1804 may comprise the MSDUs of data units 1813-1, 1813-3 and 1813-4 associated with sequence numbers 1, 3 and 4, respectively. However, as data unit 1813-2 is received in error by recipient STA 1804, the reorder buffer may not include the MSDU of data unit 1813-2 (associated with sequence number 2), resulting in an MSDU hole in the reorder buffer. In another example, data units that are received successfully by the STA 1804, before a data unit received in error, are not placed in the reorder buffer and may be directly forwarded sequentially (e.g., according to their sequence numbers) to the STA 1806.

In an example, STA 1804 may transmit to AP 1802 BA frame 1815 indicating data unit 1813-2 was received in error. After transmitting BA frame 1815, STA 1804 may transmit to STA 1806 a frame 1820. Based on STA 1806 supporting OOO delivery (indicated in frame 1811) and data unit 1813-2 being received in error, frame 1820 may comprise all MSDUs of data units that were received correctly by STA 1804 excluding the MSDU of data unit 1813-2 of frame 1810 that was received in error. For example, frame 1820 may be a PPDU comprising a unit 1821 and data units 1822-1, 1822-3 and 1822-4. Unit 1821 may comprise a PHY preamble and a PHY header of frame 1820. Data units 1822-1, 1822-3 and 1822-4 may comprise the same MSDUs of data units 1813-1, 1813-3 and 1813-4 of frame 1810. The MSDUs of data units 1822-1, 1822-3 and 1822-4 may be associated with a same or a different sequence number as the MSDU of data units 1813-1, 1813-3 and 1813-4. Sequence numbers of MSDUs in a buffer may change with a same offset for all MSDUs in a sequence, if they are to be transmitted. In example 1800, frame 1820 comprises all the data units comprising MSDUs received successfully (despite data unit 1813-2 was received in error) since STA 1806 can support OOO delivery. Accordingly, STA 1804 may not need to store any MSDU of data units received successfully in its reorder buffer.

On receiving frame 1820, STA 1806 may decode frame 1820 and determine the units that are received successfully or received in error. In an example, unit 1821 and data units 1822-1, 1822-3 and 1822-4 (with sequence numbers 1, 3 and 4, respectively) may be received successfully. In an example, supporting OOO delivery, STA 1806 may forward the MSDUs of data units 1822-1, 1822-3 and 1822-4 (with sequence numbers 1, 3 and 4, respectively) in the reorder buffer to the higher layer. In an example, STA 1806 may transmit to STA 1804 BA frame 1825 indicating data units 1822-1, 1822-3 and 1822-4 were received successfully.

After receiving BA frame 1815 and during its allocated transmission period, AP 1802 may transmit to STA 1804 frame 1830. In an example, frame 1830 may be a PPDU comprising unit 1831, where unit 1831 comprises PHY preamble and PHY header, and data units 1832-2 and 1832-5. Data unit 1832-2 with sequence number 2 may comprise the same MSDU as the data unit 1813-2 with sequence number 2, and may be retransmitted in frame 1830. Data unit 1832-5 may comprise a new data unit comprising sequence number 5.

On receiving frame 1830, STA 1804 may decode frame 1830 and determine the units that are received successfully or received in error. In an example, unit 1831 and data units 1832-2 and 1832-5 (with sequence numbers 2 and 5, respectively) may be received successfully. In an example, STA 1804 may transmit to AP 1802 BA frame 1835 indicating data units 1832-2 and 1832-5 were received successfully. In an example, STA 1804 may place the MSDU with sequence number 2 (of data unit 1832-2) in the reorder buffer. In addition, STA 1804 may place the MSDU with sequence number 5 (of data unit 1832-5) in the reorder buffer after the MSDU with sequence number 2. In another example, data units that are received successfully by the relay STA are not placed in the reorder buffer and may be directly forwarded sequentially (e.g., according to their sequence numbers) to the destination STA.

In an example, after transmitting BA frame 1835 and based on the ability of STA 1806 to support OOO delivery, STA 1804 may transmit to STA 1806 frame 1840. Frame 1840 may be a PPDU comprising unit 1841 and data units 1842-2 and 1842-5. Unit 1841 may comprise a PHY preamble and a PHY header. Data units 1842-2 and 1842-5 may comprise the same MSDUs of data units 1832-2 and 1832-5.

On receiving frame 1840, STA 1806 may decode frame 1840 and determine the units that are received successfully or received in error. In an example, unit 1841 and data units 1842-2 and 1842-5 (with sequence numbers 2 and 5, respectively) may be received successfully. In an example, supporting OOO delivery, STA 1806 may forward the MSDUs of data units 1842-2 and 1842-5 (with sequence numbers 2 and 5, respectively) in the reorder buffer to the higher layer. In an example, STA 1806 may transmit to STA 1804 BA frame 1845 indicating data units 1842-2 and 1842-5 were received successfully. As illustrated in example 1800, since AP 1802 has instructed STA 1804 of how to transmit data units to STA 1806, the transmission of MSDUs to the higher layer at STA 1806 has been more efficient.

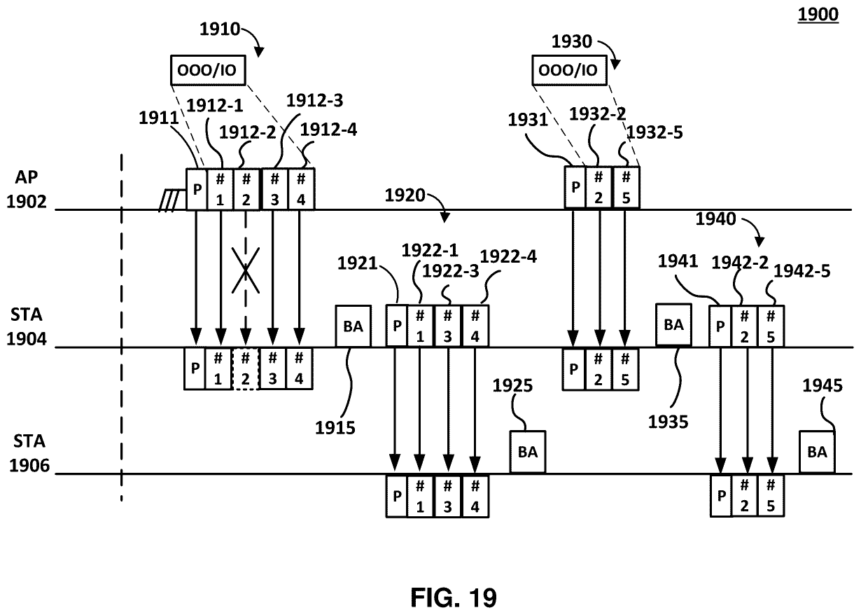

FIG. 19 illustrates another example 1900 of a relaying procedure, which may be used for relaying downlink traffic from an AP to a STA, according to an embodiment. As shown in FIG. 19, example 1900 may include an AP 1902 and a plurality of STAs 1904 and 1906. In an example, STAs 1904 and 1906 may be associated with AP 1902. In an example, AP 1902 and STAs 1904 and 1906 may be within each other's communication ranges. In an example, STA 1904 may receive data frames from AP 1902 destined to itself. In another example, STA 1904 may serve as a relay for STA 1906. For instance, AP 1902 may be configured to transmit a PPDU to STA 1906 via STA 1904 in order to increase the throughput of a downlink transmission. In an example, STAs 1904 and 1906 may support IO delivery and/or OOO delivery. For the purpose of illustration, in example 1900, it is assumed that STA 1904 may not have access to information corresponding to the capabilities of STA 1906, e.g., whether STA 1906 supports IO delivery and/or OOO delivery. In example 1900, it is assumed that AP 1902 may have access to information corresponding to the capabilities of STA 1906, e.g., whether STA 1906 supports IO delivery and/or OOO delivery.

As shown in FIG. 19, the relaying procedure may begin by AP 1902 transmitting frame 1910 to STA 1904. In an example, frame 1910 may comprise a PPDU comprising unit 1911 and data units 1912-1, 1912-2, 1912-3 and 1912-4.

In an embodiment, each of data units 1912-1, 1912-2, 1912-3 and 1912-4 may comprise an indication of whether transmission of a second data unit before a first data unit, where the second data unit follows the first data unit, is allowed. In an embodiment, the indication may be provided in an aggregated control (A-control) field of data units 1912-1, 1912-2, 1912-3 and 1912-4. In an embodiment, the A-control field may be provided in a high throughput (HT) control field of data units 1912-1, 1912-2, 1912-3 and 1912-4. In another embodiment, unit 1911 may comprise an indication of whether transmission of a second data unit before a first data unit, where the second data unit follows the first data unit, is allowed. In an embodiment, AP 1902 may be configured to provide an indication to STA 1904 as to whether STA 1906 supports IO delivery and/or OOO delivery. In another example, AP 1902 may instruct or control STA 1904 whether to perform transmission of a second data unit before a first data unit, when the first data unit is received in error. In an embodiment, AP 1902 may determine whether OOO transmission of data units is indicated for example 1900 based on the data unit delivery capabilities of STA 1906 (e.g., supporting IO delivery and/or OOO delivery). In an example, AP 1902 may obtain the data unit delivery capabilities of STA 1906 directly from STA 1906. In another example, AP 1902 may determine whether OOO transmission of data units is indicated for example 1900 based on the necessity for a faster delivery of higher priority (e.g., low latency) data units to STA 1906 and/or to lower reorder buffer congestion at STA 1904, considering the data unit delivery capabilities of STA 1906, during a relay operation. In an embodiment, the indication may comprise a first indication that transmission of the second data unit before the first data unit is to be performed when the first data unit is received in error.

In example 1900, AP 1902 may transmit one or more data units within frame 1910. In an example, frame 1910 may be a PPDU comprising unit 1911 and data units 1912-1, 1912-2, 1912-3 and 1912-4. Unit 1911 may comprise a PHY preamble and a PHY header (collectively denoted “P” in frame 1910). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 1912-1, 1912-2, 1912-3 and 1912-4 may comprise sequence numbers 1, 2, 3 and 4, respectively, as illustrated in FIG. 19. In an example, frame 1910 may further comprise a block ack request (BAR) (not shown in FIG. 19). When present, the BAR indicates that AP 1902 requests a block ack (BA) frame in response to frame 1910.

In an example, STA 1904 may receive frame 1910 transmitted by AP 1902. Based on the indication, STA 1904 may determine that AP 1902 instructs or controls STA 1904 to transmit a second data unit before a first data unit, if the first data unit is received in error. In an example, STA 1904 considers the indication for all data units to be transmitted to STA 1906. By decoding the rest of frame 1910, STA 1904 may determine the units that are received successfully or received in error, including each of data units 1912-1, 1912-2, 1912-3 and 1912-4. A data unit that STA 1904 can decode successfully (e.g., for which an FCS check is successful) may be considered as received successfully by STA 1904. In contrast, a data unit that STA 1904 fails to decode successfully (e.g., for which an FCS check fails) may be considered as received in error by STA 1904. In example 1900, it is assumed data units 1912-1 (with sequence number 1), 1912-3 (with sequence number 3) and 1912-4 (with sequence number 4) are received successfully by STA 1904 but that data unit 1912-2 (with sequence number 2) is received in error by STA 1904. The MSDUs of data units that are received successfully by recipient STA 1904 are placed in the reorder buffer of STA 1904 according to their sequence numbers. The MSDUs of data units that are received in error by recipient STA 1904 are not placed in the reorder buffer and their corresponding locations in the reorder buffer are kept empty (e.g., creating one or more MSDU holes in the reorder buffer). As such, in example 1900, the reorder buffer of STA 1904 may comprise the MSDUs of data units 1912-1, 1912-3 and 1912-4 associated with sequence numbers 1, 3 and 4, respectively. However, as data unit 1912-2 is received in error by recipient STA 1904, the reorder buffer may not include the MSDU of data unit 1912-2 (associated with sequence number 2), resulting in an MSDU hole in the reorder buffer. In another example, data units that are received successfully by the STA 1904, before a data unit received in error, are not placed in the reorder buffer and may be directly forwarded sequentially (e.g., according to their sequence numbers) to the STA 1906.

In an example, STA 1904 may transmit to AP 1902 BA frame 1915 indicating data unit 1912-2 was received in error. After transmitting BA frame 1915, STA 1904 may transmit to STA 1906 a frame 1920. Based on STA 1906 supporting OOO delivery (indicated in frame 1910) and data unit 1912-2 being received in error, frame 1920 may comprise all MSDUs of data units that were received correctly by STA 1904 excluding the MSDU of data unit 1912-2 of frame 1910 that was received in error. For example, frame 1920 may be a PPDU comprising a unit 1921 and data units 1922-1, 1922-3 and 1922-4. Unit 1921 may comprise a PHY preamble and a PHY header of frame 1920. Data units 1922-1, 1922-3 and 1922-4 may comprise the same MSDUs of data units 1912-1, 1912-3 and 1912-4 of frame 1910. The MSDUs of data units 1922-1, 1922-3 and 1922-4 may be associated with a same or a different sequence number as the MSDU of data units 1912-1, 1912-3 and 1912-4. Sequence numbers of MSDUs in a buffer may change with a same offset for all MSDUs in a sequence, if they are to be transmitted. In example 1900, frame 1920 comprises all the data units comprising MSDUs received successfully (despite data unit 1912-2 was received in error) since STA 1906 can support OOO delivery. Accordingly, STA 1904 may not need to store any MSDU of data units received successfully in its reorder buffer.

On receiving frame 1920, STA 1906 may decode frame 1920 and determine the units that are received successfully or received in error. In an example, unit 1921 and data units 1922-1, 1922-3 and 1922-4 (with sequence numbers 1, 3 and 4, respectively) may be received successfully. In an example, supporting OOO delivery, STA 1906 may forward the MSDUs of data units 1922-1, 1922-3 and 1922-4 (with sequence numbers 1, 3 and 4, respectively) in the reorder buffer to the higher layer. In an example, STA 1906 may transmit to STA 1904 BA frame 1925 indicating data units 1922-1, 1922-3 and 1922-4 were received successfully.

After receiving BA frame 1915 and during its allocated transmission period, AP 1902 may transmit to STA 1904 frame 1930. In an example, frame 1930 may be a PPDU comprising unit 1931, where unit 1931 comprises PHY preamble and PHY header, and data units 1932-2 and 1932-5. Data unit 1932-2 with sequence number 2 may comprise the same MSDU as the data unit 1912-2 with sequence number 2, and may be retransmitted in frame 1930. Data unit 1932-5 may comprise a new data unit comprising sequence number 5.

In an embodiment, each of data units 1932-2 and 1932-5 may comprise an indication that transmission of the second data unit before the first data unit is to be performed when the first data unit is received in error. In an embodiment, the indication may be provided in an aggregated control (A-control) field of data units 1932-2 and 1932-5. In an embodiment, the A-control field may be provided in a high throughput (HT) control field of data units 1932-2 and 1932-5. In another embodiment, unit 1931 may comprise an indication that transmission of the second data unit before the first data unit is to be performed when the first data unit is received in error.

On receiving frame 1930, STA 1904 may decode frame 1930 and determine the units that are received successfully or received in error. In an example, unit 1931 and data units 1932-2 and 1932-5 (with sequence numbers 2 and 5, respectively) may be received successfully. In an example, STA 1904 may transmit to AP 1902 BA frame 1935 indicating data units 1932-2 and 1932-5 were received successfully. In an example, STA 1904 may place the MSDU with sequence number 2 (of data unit 1932-2) in the reorder buffer. In addition, STA 1904 may place the MSDU with sequence number 5 (of data unit 1932-5) in the reorder buffer after the MSDU with sequence number 2. In another example, data units that are received successfully by the relay STA are not placed in the reorder buffer and may be directly forwarded sequentially (e.g., according to their sequence numbers) to the destination STA.

In an example, after transmitting BA frame 1935 and based on the ability of STA 1906 to support OOO delivery, STA 1904 may transmit to STA 1906 frame 1940. Frame 1940 may be a PPDU comprising unit 1941 and data units 1942-2 and 1942-5. Unit 1941 may comprise a PHY preamble and a PHY header. Data units 1942-2 and 1942-5 may comprise the same MSDUs of data units 1932-2 and 1932-5.

On receiving frame 1940, STA 1906 may decode frame 1940 and determine the units that are received successfully or received in error. In an example, unit 1941 and data units 1942-2 and 1942-5 (with sequence numbers 2 and 5, respectively) may be received successfully. In an example, supporting OOO delivery, STA 1906 may forward the MSDUs of data units 1942-2 and 1942-5 (with sequence numbers 2 and 5, respectively) in the reorder buffer to the higher layer. In an example, STA 1906 may transmit to STA 1904 BA frame 1945 indicating data units 1942-2 and 1942-5 were received successfully. As illustrated in example 1900, since AP 1902 has instructed STA 1904 of how to transmit data units to STA 1906, the transmission of MSDUs to the higher layer at the destination STA has been more efficient.

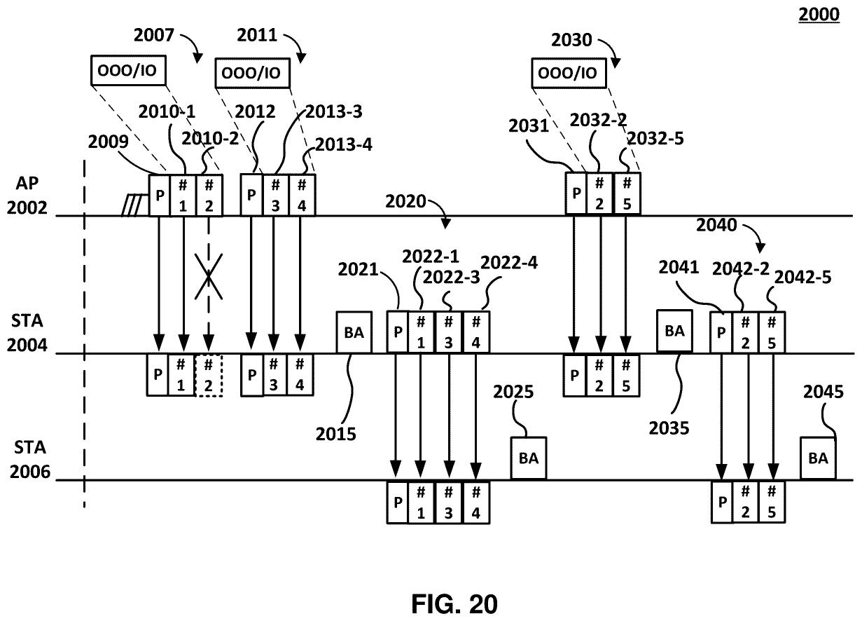

FIG. 20 illustrates another example 2000 of a relaying procedure, which may be used for relaying downlink traffic from an AP to a STA, according to an embodiment. As shown in FIG. 20, example 2000 may include an AP 2002 and a plurality of STAs 2004 and 2006. In an example, STAs 2004 and 2006 may be associated with AP 2002. In an example, AP 2002 and STAs 2004 and 2006 may be within each other's communication ranges. In an example, STA 2004 may receive data frames from AP 2002 destined to itself. In another example, STA 2004 may serve as a relay for STA 2006. For instance, AP 2002 may be configured to transmit a PPDU to STA 2006 via STA 2004 in order to increase the throughput of a downlink transmission. In an example, STAs 2004 and 2006 may support IO delivery and/or OOO delivery. For the purpose of illustration, in example 2000, it is assumed that STA 2004 may not have access to information corresponding to the capabilities of STA 2006, e.g., whether STA 2006 supports IO delivery and/or OOO delivery. In example 2000, it is assumed that AP 2002 may have access to information corresponding to the capabilities of STA 2006, e.g., whether STA 2006 supports IO delivery and/or OOO delivery.

In an example, AP 2002 may transmit one or more frames comprising multiple data units to STA 2004 to be forwarded to STA 2006. As shown in FIG. 20, the relaying procedure may begin by AP 2002 transmitting frame 2007 to STA 2004. In an example, frame 2007 may comprise a PPDU comprising unit 2009 and data units 2010-1 and 2010-2.

In an embodiment, each of data units 2010-1 and 2010-2 may comprise an indication of whether transmission of a second data unit before a first data unit, where the second data unit follows the first data unit, is allowed. In an embodiment, the indication may be provided in an aggregated control (A-control) field of data units 2010-1 and 2010-2. In an embodiment, the A-control field may be provided in a high throughput (HT) control field of data units 2010-1 and 2010-2. In another embodiment, unit 2009 may comprise an indication of whether transmission of a second data unit before a first data unit, where the second data unit follows the first data unit, is allowed. In an embodiment, AP 2002 may be configured to provide an indication to STA 2004 as to whether STA 2006 supports IO delivery and/or OOO delivery. In another example, AP 2002 may instruct or control STA 2004 whether to perform transmission of a second data unit before a first data unit, when the first data unit is received in error. In an embodiment, AP 2002 may determine whether OOO transmission of data units is indicated for example 2000 based on the data unit delivery capabilities of STA 2006 (e.g., supporting IO delivery and/or OOO delivery). In an example, AP 2002 may obtain the data unit delivery capabilities of STA 2006 directly from STA 2006. In another example, AP 2002 may determine whether OOO transmission of data units is indicated for example 2000 based on the necessity for a faster delivery of higher priority (e.g., low latency) data units to STA 2006 and/or to lower reorder buffer congestion at STA 2004, considering the data unit delivery capabilities of STA 2006, during a relay operation. In an embodiment, the indication may comprise a first indication that transmission of the second data unit before the first data unit is to be performed when the first data unit is received in error.

In example 2000, AP 2002 may transmit one or more data units within frame 2007. In an example, frame 2007 may be a PPDU comprising unit 2009 and data units 2010-1 and 2010-2. Unit 2009 may comprise a PHY preamble and a PHY header (collectively denoted “P” in frame 2007). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 2010-1 and 2010-2 may comprise sequence numbers 1 and 2, respectively, as illustrated in FIG. 20. In an example, frame 2007 may further comprise a block ack request (BAR) (not shown in FIG. 20). When present, the BAR indicates that AP 2002 requests a block ack (BA) frame in response to frame 2007. In another example, frame 2007 may not comprise a BAR.

In an example, STA 2004 may receive frame 2007 transmitted by AP 2002. Based on the indication, STA 2004 may determine that AP 2002 instructs or controls STA 2004 to transmit a second data unit before a first data unit, if the first data unit is received in error. In an example, STA 2004 considers the indication for all data units to be transmitted to STA 2006. By decoding the rest of frame 2007, STA 2004 may determine the units that are received successfully or received in error, including each of data units 2010-1 and 2010-2. A data unit that STA 2004 can decode successfully (e.g., for which an FCS check is successful) may be considered as received successfully by STA 2004. In contrast, a data unit that STA 2004 fails to decode successfully (e.g., for which an FCS check fails) may be considered as received in error by STA 2004. In example 2000, it is assumed data unit 2010-1 (with sequence number 1) is received successfully by STA 2004 but that data unit 2010-2 (with sequence number 2) is received in error by STA 2004. The MSDUs of data units that are received successfully by recipient STA 2004 are placed in the reorder buffer of STA 2004 according to their sequence numbers. The MSDUs of data units that are received in error by recipient STA 2004 are not placed in the reorder buffer and their corresponding locations in the reorder buffer are kept empty (e.g., creating one or more MSDU holes in the reorder buffer). As such, in example 2000, the reorder buffer of STA 2004 may comprise the MSDU of data unit 2010-1 associated with sequence number 1. However, as data unit 2010-2 is received in error by recipient STA 2004, the reorder buffer may not include the MSDU of data unit 2010-2 (associated with sequence number 2), resulting in an MSDU hole in the reorder buffer. In another example, data units that are received successfully by the STA 2004, before a data unit received in error, are not placed in the reorder buffer and may be directly forwarded sequentially (e.g., according to their sequence numbers) to the STA 2006.

In example 2000, after transmitting frame 2007, AP 2002 may transmit frame 2011 to STA 2004. In an example, frame 2011 may be a PPDU comprising unit 2012 and data units 2013-3 and 2013-4. Unit 2012 may comprise a PHY preamble and a PHY header (collectively denoted “P” in frame 2011). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In an example, data units 2013-3 and 2013-4 may comprise sequence numbers 3 and 4, respectively, as illustrated in FIG. 20. In an example, frame 2011 may further comprise a block ack request (BAR) (not shown in FIG. 20). When present, the BAR indicates that AP 2002 requests a block ack (BA) frame in response to frame 2007.

In an embodiment, each of data units 2013-3 and 2013-4 may comprise an indication of whether transmission of a second data unit before a first data unit, where the second data unit follows the first data unit, is allowed. In an embodiment, the indication may be provided in an aggregated control (A-control) field of data units 2013-3 and 2013-4. In an embodiment, the A-control field may be provided in a high throughput (HT) control field of data units 2013-3 and 2013-4. In another embodiment, unit 2012 may comprise an indication of whether transmission of the second data unit before the first data unit is to be performed when the first data unit is received in error. In an embodiment, the indication may comprise a first indication that transmission of the second data unit before the first data unit is to be performed when the first data unit is received in error.

In an example, STA 2004 may receive frame 2011 transmitted by AP 2002. By decoding frame 2011, STA 2004 may determine the units that are received successfully or received in error. In an example, unit 2012 and data units 2013-3 (with sequence number 3) and 2013-4 (with sequence number 4) may be received successfully. The MSDUs of data units that are received successfully are placed in the reorder buffer according to their sequence numbers. In example 2000, the reorder buffer of STA 2004 may comprise MSDUs of data units 2010-1, 2013-3, and 2013-4 associated with sequence numbers 1, 3 and 4. However, as data unit 2010-2 is received in error by recipient STA 2004, the reorder buffer may not include the MSDU of data unit 2010-2 (associated with sequence number 2), resulting in an MSDU hole in the reorder buffer. In another example, data units that are received successfully by the STA 2004, before a data unit received in error, are not placed in the reorder buffer and may be directly forwarded sequentially (e.g., according to their sequence numbers) to the STA 2006. In an embodiment, AP 2002 may have requested STA 2004 forward data units that are received successfully after STA 2004 has received frame 2011.

In an example, STA 2004 may transmit to AP 2002 BA frame 2015 indicating data unit 2010-2 was received in error. After transmitting BA frame 2015, STA 2004 may transmit to STA 2006 a frame 2020. Based on STA 2006 supporting OOO delivery (indicated in frame 2007 and frame 2011) and data unit 2010-2 being received in error, frame 2020 may comprise all MSDUs of data units that were received correctly by STA 2004 excluding the MSDU of data unit 2010-2 of frame 2007 that was received in error. For example, frame 2020 may be a PPDU comprising a unit 2021 and data units 2022-1, 2022-3 and 2022-4. Unit 2021 may comprise a PHY preamble and a PHY header of frame 2020. Data units 2022-1, 2022-3 and 2022-4 may comprise the same MSDUs of data unit 2010-1 of frame 2007 and data units 2013-3 and 2013-4 of frame 2011. The MSDUs of data units 2022-1, 2022-3 and 2022-4 may be associated with a same or a different sequence number as the MSDU of data units 2010-1, 2013-3 and 2013-4. Sequence numbers of MSDUs in a buffer may change with a same offset for all MSDUs in a sequence, if they are to be transmitted. In example 2000, frame 2020 comprises all the data units comprising MSDUs received successfully (despite data unit 2010-2 was received in error) since STA 2006 can support OOO delivery. Accordingly, STA 2004 may not need to store any MSDU of data units received successfully in its reorder buffer.

On receiving frame 2020, STA 2006 may decode frame 2020 and determine the units that are received successfully or received in error. In an example, unit 2021 and data units 2022-1, 2022-3 and 2022-4 (with sequence numbers 1, 3 and 4, respectively) may be received successfully. In an example, supporting OOO delivery, STA 2006 may forward the MSDUs of data units 2022-1, 2022-3 and 2022-4 (with sequence numbers 1, 3 and 4, respectively) in the reorder buffer to the higher layer. In an example, STA 2006 may transmit to STA 2004 BA frame 2025 indicating data units 2022-1, 2022-3 and 2022-4 were received successfully.

After receiving BA frame 2015 and during its allocated transmission period, AP 2002 may transmit to STA 2004 frame 2030. In an example, frame 2030 may be a PPDU comprising unit 2031, where unit 2031 comprises PHY preamble and PHY header, and data units 2032-2 and 2032-5. Data unit 2032-2 with sequence number 2 may comprise the same MSDU as the data unit 2010-2 with sequence number 2, and may be retransmitted in frame 2030. Data unit 2032-5 may comprise a new data unit comprising sequence number 5.

In an embodiment, each of data units 2032-2 and 2032-5 may comprise an indication that transmission of the second data unit before the first data unit is to be performed when the first data unit is received in error. In an embodiment, the indication may be provided in an aggregated control (A-control) field of data units 2032-2 and 2032-5. In an embodiment, the A-control field may be provided in a high throughput (HT) control field of data units 2032-2 and 2032-5. In another embodiment, unit 2031 may comprise an indication that transmission of the second data unit before the first data unit is to be performed when the first data unit is received in error.

On receiving frame 2030, STA 2004 may decode frame 2030 and determine the units that are received successfully or received in error. In an example, unit 2031 and data units 2032-2 and 2032-5 (with sequence numbers 2 and 5, respectively) may be received successfully. In an example, STA 2004 may transmit to AP 2002 BA frame 2035 indicating data units 2032-2 and 2032-5 were received successfully. In an example, STA 2004 may place the MSDU with sequence number 2 (of data unit 2032-2) in the reorder buffer. In addition, STA 2004 may place the MSDU with sequence number 5 (of data unit 2032-5) in the reorder buffer after the MSDU with sequence number 2. In another example, data units that are received successfully by the relay STA are not placed in the reorder buffer and may be directly forwarded sequentially (e.g., according to their sequence numbers) to the destination STA.

In an example, after transmitting BA frame 2035 and based on the ability of STA 2006 to support OOO delivery, STA 2004 may transmit to STA 2006 frame 2040. Frame 2040 may be a PPDU comprising unit 2041 and data units 2042-2 and 2042-5. Unit 2041 may comprise a PHY preamble and a PHY header. Data units 2042-2 and 2042-5 may comprise the same MSDUs of data units 2032-2 and 2032-5.

On receiving frame 2040, STA 2006 may decode frame 2040 and determine the units that are received successfully or received in error. In an example, unit 2041 and data units 2042-2 and 2042-5 (with sequence numbers 2 and 5, respectively) may be received successfully. In an example, supporting OOO delivery, STA 2006 may forward the MSDUs of data units 2042-2 and 2042-5 (with sequence numbers 2 and 5, respectively) in the reorder buffer to the higher layer. In an example, STA 2006 may transmit to STA 2004 BA frame 2045 indicating data units 2042-2 and 2042-5 were received successfully. As illustrated in example 2000, since AP 2002 has instructed STA 2004 of how to transmit data units to STA 2006, the transmission of MSDUs to the higher layer at the destination STA has been more efficient.

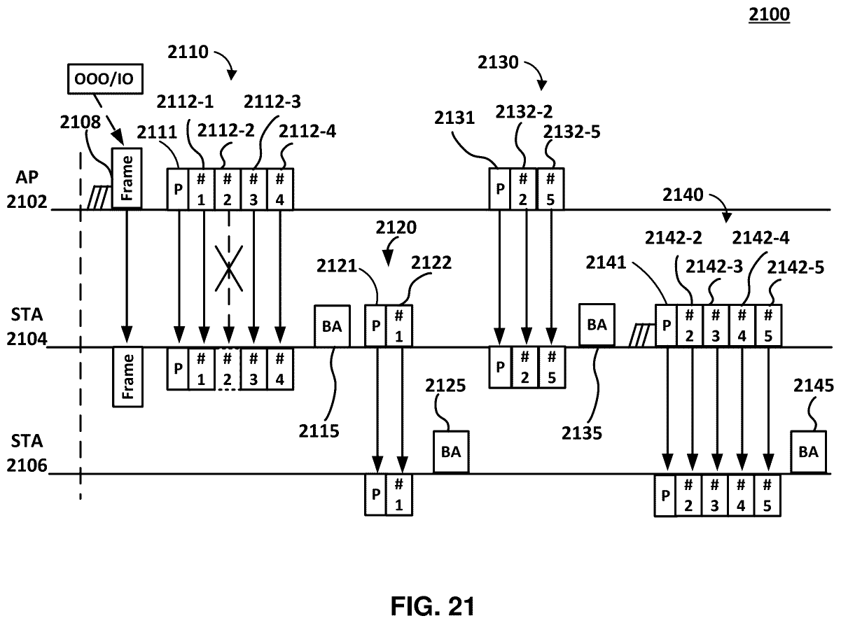

FIG. 21 illustrates another example 2100 of a relaying procedure, which may be used for relaying downlink traffic from an AP to a STA, according to an embodiment. As shown in FIG. 21, example 2100 may include an AP 2102 and a plurality of STAs 2104 and 2106. In an example, STAs 2104 and 2106 may be associated with AP 2102. In an example, AP 2102 and STAs 2104 and 2106 may be within each other's communication ranges. In an example, STA 2104 may receive data frames from AP 2102 destined to itself. In another example, STA 2104 may serve as a relay for STA 2106. For instance, AP 2102 may be configured to transmit a PPDU to STA 2106 via STA 2104 in order to increase the throughput of a downlink transmission. In an example, STA 2104 may support IO delivery and/or OOO delivery. In an example, STA 2106 may support IO delivery but not OOO delivery. For the purpose of illustration, in example 2100, it is assumed that STA 2104 may not have access to information corresponding to the capabilities of STA 2106, e.g., whether STA 2106 supports IO delivery and/or OOO delivery. In example 2100, it is assumed that AP 2102 may have access to information corresponding to the capabilities of STA 2106, e.g., whether STA 2106 supports IO delivery and/or OOO delivery.

As shown in FIG. 21, the relaying procedure may begin by AP 2102 transmitting frame 2108 to STA 2104. In an embodiment, frame 2108 may comprise an indication of whether transmission of a second data unit before a first data unit, where the second data unit follows the first data unit, is allowed. In an embodiment, AP 2102 may be configured to provide an indication to STA 2104 as to whether STA 2106 supports IO delivery and/or OOO delivery. In another example, AP 2102 may instruct or control STA 2104 whether to perform transmission of a second data unit before a first data unit, when the first data unit is received in error.

In an embodiment, AP 2102 may determine whether OOO transmission of data units is indicated for example 2100 based on the data unit delivery capabilities of STA 2106 (e.g., supporting IO delivery and/or OOO delivery). In an example, AP 2102 may obtain the data unit delivery capabilities of STA 2106 directly from STA 2106. In another example, AP 2102 may determine whether OOO transmission of data units is indicated for example 2100 based on the necessity for a faster delivery of higher priority (e.g., low latency) data units to STA 2106 and/or to lower reorder buffer congestion at STA 2104, considering the data unit delivery capabilities of STA 2106, during a relay operation.

In example 2100, AP 2102 may transmit frame 2108 to STA 2104 before transmitting data units to be forwarded to STA 2106. In an embodiment, frame 2108 may comprise a management frame. In an embodiment, the management frame may comprise an action frame. In an embodiment, the indication may comprise a second indication that transmission of the second data unit before the first data unit is not to be performed when the first data unit is received in error. In another embodiment, the indication may be provided in a frame aggregated to a PPDU, as in FIG. 17 and FIG. 18 (not shown in FIG. 21). In another embodiment, the indication may be provided in one or more data units or in the PHY header, as in FIG. 19 and FIG. 20 (not shown in FIG. 21).

In an example, STA 2104 may receive frame 2108 transmitted by AP 2102. Based on the indication in frame 2108 (or based on the indication that may have been provided as in FIGS. 17-20), STA 2104 may determine that AP 2102 instructs or controls STA 2104 not to transmit a second data unit before a first data unit, if the first data unit is received in error. In an example, STA 2104 considers the indication for all data units to be transmitted to STA 2106.

In example 2100, after transmitting frame 2108, AP 2102 may transmit frame 2110. In an example, frame 2110 may be a PPDU comprising a unit 2111 and data units 2112-1, 2112-2, 2112-3 and 2112-4. Unit 2111 may comprise a PHY preamble and a PHY header (collectively denoted “P” in frame 2110). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 2100, data units 2112-1, 2112-2, 2112-3 and 2112-4 may comprise sequence numbers 1, 2, 3 and 4, respectively, as illustrated in FIG. 21. In an example, frame 2110 may further comprise a block ack request (BAR) (not shown in FIG. 21). When present, the BAR indicates that AP 2102 requests a block ack (BA) frame in response to frame 2110.

In an example, STA 2104 may receive frame 2110 transmitted by AP 2102. On receiving frame 2110, STA 2104 may decode frame 2110, including decoding each of data units 2112-1, 2112-2, 2112-3, and 2112-4. A data unit that STA 2104 can decode successfully (e.g., for which an FCS check is successful) may be considered as received successfully by STA 2104. In contrast, a data unit that STA 2104 fails to decode successfully (e.g., for which an FCS check fails) may be considered as received in error by STA 2104. In example 2100, it is assumed data units 2112-1 (with sequence number 1), 2112-3 (with sequence number 3), and 2112-4 (with sequence number 4) are received successfully by STA 2104 but that data unit 2112-2 (with sequence number 2) is received in error by recipient STA 2104. The MSDUs of data units that are received successfully by recipient STA 2104 are placed in the reorder buffer of STA 2104 according to their sequence numbers. The MSDUs of data units that are received in error by recipient STA 2104 are not placed in the reorder buffer and their corresponding locations in the reorder buffer are kept empty (e.g., creating one or more MSDU holes in the reorder buffer). As such, in example 2100, the reorder buffer of STA 2104 may comprise MSDUs of data units 2112-1, 2112-3, and 2112-4 associated with sequence numbers 1, 3 and 4. However, as data unit 2112-2 is received in error by recipient STA 2104, the reorder buffer may not include the MSDU of data unit 2112-2 (associated with sequence number 2), resulting in an MSDU hole in the reorder buffer. In another example, data units that are received successfully by the relay STA, before a data unit received in error, are not placed in the reorder buffer and may be directly forwarded sequentially (e.g., according to their sequence numbers) to STA 2106. As such, data units that are received successfully after the data unit received in error may be placed in the reorder buffer.

In an example, STA 2104 may transmit to AP 2102 a BA frame 2115 indicating that data unit 2112-2 was received in error by STA 2104. After transmitting BA frame 2115, STA 2104 may transmit to STA 2106 a frame 2120. Based on STA 2106 supporting only IO delivery and data unit 2112-2 being received error, frame 2120 may comprise only the MSDU of data unit 2112-1 of frame 2110. For example, frame 2120 may be a PPDU comprising a unit 2121 and a data unit 2122. Unit 2121 may comprise a PHY preamble and a PHY header of frame 2120. Data unit 2122 may comprise the same MSDU of data unit 2112-1 of frame 2110. The MSDU of data unit 2122 may be associated with a same or a different sequence number as the MSDU of data unit 2112-1. Sequence numbers of MSDUs in a buffer may change with a same offset for all MSDUs in a sequence, if they are to be transmitted. As only the MSDU (or A-MSDU) of data unit 2112-1 is transmitted in frame 2120, STA 2104 may store MSDUs of data units 2112-3 and 2112-4 with sequence numbers 3 and 4, respectively, in its reorder buffer. STA 2104 may transmit the MSDUs of data units 2112-3 and 2112-4 only after receiving the MSDU of data unit 2112-2 with sequence number 2 successfully (MSDU with sequence number 2 will be received in a different data unit).

On receiving frame 2120, STA 2106 may decode frame 2120 and determine the units that are received successfully or received in error. In an example, unit 2121 and data unit 2122 (with sequence number 1) may be received successfully. In an example, supporting IO delivery, STA 2106 may forward the MSDU of data unit 2122 (with sequence number 1) in the reorder buffer to the higher layer. In an example, STA 2106 may transmit to STA 2104 BA frame 2125 indicating data unit 2122 was received successfully.

After receiving BA frame 2115 and during its allocated transmission period, AP 2102 may transmit to STA 2104 frame 2130. In an example, frame 2130 may be a PPDU comprising unit 2131, where unit 2131 comprises PHY preamble and PHY header, and data units 2132-2 and 2132-5. Data unit 2132-2 with sequence number 2 may comprise the same MSDU as the data unit 2112-2 with sequence number 2, and may be retransmitted in frame 2130. Data unit 2132-5 may comprise a new data unit comprising sequence number 5.

On receiving frame 2130, STA 2104 may decode frame 2130 and determine the units that are received successfully or received in error. In an example, unit 2131 and data units 2132-2 and 2132-5 (with sequence numbers 2 and 5, respectively) may be received successfully. In an example, STA 2104 may transmit to AP 2102 BA frame 2135 indicating data units 2132-2 and 2132-5 were received successfully. In an example, STA 2104 may place the MSDU with sequence number 2 (of data unit 2132-2) in the reorder buffer before earlier received MSDUs with sequence numbers 3 and 4. In addition, STA 2104 may place the MSDU with sequence number 5 (of data unit 2132-5) in the reorder buffer after earlier received MSDUs with sequence numbers 3 and 4.

In an example, after transmitting BA frame 2135 and based on the ability of STA 2106 to support IO delivery, STA 2104 may transmit to STA 2106 frame 2140. Frame 2140 may be a PPDU comprising unit 2141 data units 2142-2, 2142-3, 2142-4 and 2142-5. Unit 2141 may comprise a PHY preamble and a PHY header of frame 2140. Data units 2142-2, 2142-3, 2142-4 and 2142-5 may comprise the same MSDUs of data units 2132-2, 2112-3, 2112-4 and 2132-5.

On receiving frame 2140, STA 2106 may decode frame 2140 and determine the units that are received successfully or received in error. In an example, unit 2141 and data units 2142-2, 2142-3, 2142-4 and 2142-5 (with sequence numbers 2, 3, 4 and 5, respectively) may be received successfully. In an example, supporting IO delivery, STA 2106 may forward the MSDUs of data units 2142-2, 2142-3, 2142-4 and 2142-5 (with sequence numbers 2, 3, 4 and 5, respectively) in the reorder buffer to the higher layer. In an example, STA 2106 may transmit to STA 2104 BA frame 2145 indicating data units 2142-2, 2142-3, 2142-4 and 2142-5 were received successfully. As illustrated in example 2100, since AP 2102 has instructed STA 2104 of how to transmit data units to STA 2106, the transmission of MSDUs to the higher layer at the destination STA has been more efficient.

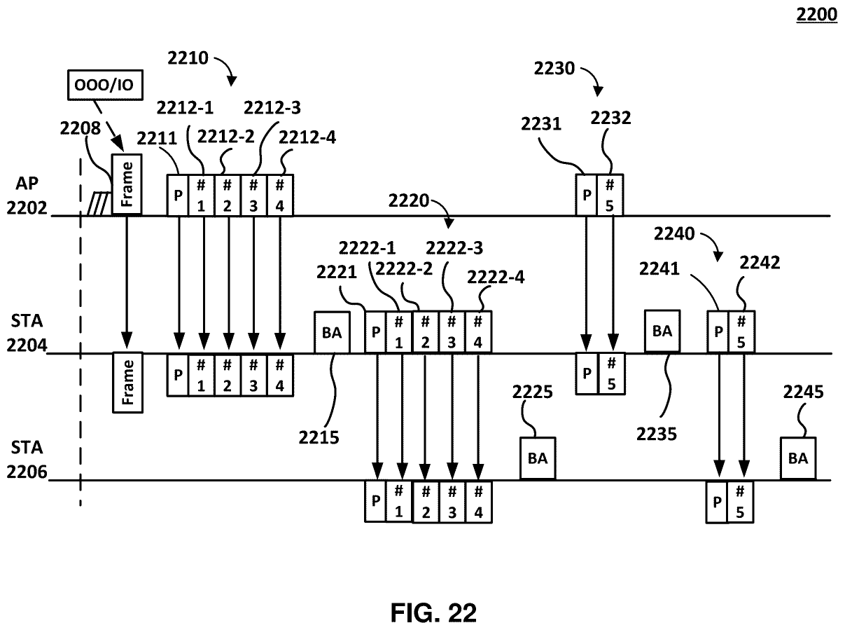

FIG. 22 illustrates another example 2200 of a relaying procedure, which may be used for relaying downlink traffic from an AP to a STA, according to an embodiment. As shown in FIG. 22, example 2200 may include an AP 2202 and a plurality of STAs 2204 and 2206. In an example, STAs 2204 and 2206 may be associated with AP 2202. In an example, AP 2202 and STAs 2204 and 2206 may be within each other's communication ranges. In an example, STA 2204 may receive data frames from AP 2202 destined to itself. In another example, STA 2204 may serve as a relay for STA 2206. For instance, AP 2202 may be configured to transmit a PPDU to STA 2206 via STA 2204 in order to increase the throughput of a downlink transmission. In an example, STA 2204 may support IO delivery and/or OOO delivery. In an example, STA 2206 may support IO delivery but not OOO delivery. In another example, STA 2206 may support IO delivery and/or OOO delivery. For the purpose of illustration, in example 2200, it is assumed that STA 2204 may not have access to information corresponding to the capabilities of STA 2206, e.g., whether STA 2206 supports IO delivery and/or OOO delivery. In example 2200, it is assumed that AP 2202 may have access to information corresponding to the capabilities of STA 2206, e.g., whether STA 2206 supports IO delivery and/or OOO delivery.

As shown in FIG. 22, the relaying procedure may begin by AP 2202 transmitting frame 2208 to STA 2204. In an embodiment, frame 2208 may comprise an indication of whether transmission of a second data unit before a first data unit, where the second data unit follows the first data unit, is allowed. In an embodiment, AP 2202 may be configured to provide an indication to STA 2204 as to whether STA 2206 supports IO delivery and/or OOO delivery. In another example, AP 2202 may instruct or control STA 2204 whether to perform transmission of a second data unit before a first data unit, when the first data unit is received in error.

In an embodiment, AP 2202 may determine whether OOO transmission of data units is indicated for example 2200 based on the data unit delivery capabilities of STA 2206 (e.g., supporting IO delivery and/or OOO delivery). In an example, AP 2202 may obtain the data unit delivery capabilities of STA 2206 directly from STA 2206. In another example, AP 2202 may determine whether OOO transmission of data units is indicated for example 2200 based on the necessity for a faster delivery of higher priority (e.g., low latency) data units to STA 2206 and/or to lower reorder buffer congestion at STA 2204, considering the data unit delivery capabilities of STA 2206, during a relay operation.

In example 2200, AP 2202 may transmit frame 2208 to STA 2204 before transmitting data units to be forwarded to STA 2206. In an embodiment, frame 2208 may comprise a management frame. In an embodiment, the management frame may comprise an action frame. In an embodiment, the indication may comprise a first indication that transmission of the second data unit before the first data unit is not to be performed when the first data unit is received in error. In another embodiment, the indication may comprise a second indication that transmission of the second data unit before the first data unit is not to be performed. In another embodiment, the indication may be provided in a frame aggregated to a PPDU, as in FIG. 17 and FIG. 18 (not shown in FIG. 22). In another embodiment, the indication may be provided in one or more data units or in the PHY header, as in FIG. 19 and FIG. 20 (not shown in FIG. 22).

In an example, STA 2204 may receive frame 2208 transmitted by AP 2202. Based on the indication in frame 2208 (or based on the indication that may have been provided as in FIGS. 17-20), STA 2204 may determine that AP 2202 instructs or controls STA 2204 not to transmit a second data unit before a first data unit, if the first data unit is received in error. In another example, based on the indication in frame 2208 (or based on the indication that may have been provided as in FIGS. 17-20), STA 2204 may determine that AP 2202 instructs or controls STA 2204 to transmit a second data unit before a first data unit, if the first data unit is received in error. In an example, STA 2204 considers the indication for all data units to be transmitted to STA 2206.

In example 2200, after transmitting frame 2208, AP 2202 may transmit frame 2210. In an example, frame 2210 may be a PPDU comprising a unit 2211 and data units 2212-1, 2212-2, 2212-3 and 2212-4. Unit 2211 may comprise a PHY preamble and a PHY header (collectively denoted “P” in frame 2210). In an example, a data unit may be an MPDU comprising an MSDU. In another example, a data unit may be an MPDU comprising multiple MSDUs or an A-MSDU. In an example, each data unit may comprise or may be associated with a sequence number associated with an MSDU or an A-MSDU. In example 2200, data units 2212-1, 2212-2, 2212-3 and 2212-4 may comprise sequence numbers 1, 2, 3 and 4, respectively, as illustrated in FIG. 22. In an example, frame 2210 may further comprise a block ack request (BAR) (not shown in FIG. 22). When present, the BAR indicates that AP 2202 requests a block ack (BA) frame in response to frame 2210.

In an example, STA 2204 may receive frame 2210 transmitted by AP 2202. On receiving frame 2210, STA 2204 may decode frame 2210, including decoding each of data units 2212-1, 2212-2, 2212-3, and 2212-4. A data unit that STA 2204 can decode successfully (e.g., for which an FCS check is successful) may be considered as received successfully by STA 2204. In contrast, a data unit that STA 2204 fails to decode successfully (e.g., for which an FCS check fails) may be considered as received in error by STA 2204. In example 2200, it is assumed data units 2212-1 (with sequence number 1), 2212-2 (with sequence number 2), 2212-3 (with sequence number 3), and 2212-4 (with sequence number 4) are all received successfully by STA 2204. The MSDUs of data units that are received successfully by recipient STA 2204 are placed in the reorder buffer of STA 2204 according to their sequence numbers. As such, in example 2200, the reorder buffer of STA 2204 may comprise MSDUs of data units 2212-1, 2212-2, 2212-3, and 2212-4 associated with sequence numbers 1, 2, 3 and 4. In another example, data units that are received successfully by the relay STA are not placed in the reorder buffer and may be directly forwarded sequentially (e.g., according to their sequence numbers) to STA 2206.

In an example, STA 2204 may transmit to AP 2202 BA frame 2215 indicating data units 2212-1, 2212-2, 2212-3 and 2212-4 were all received successfully. After transmitting BA frame 2215, whether IO delivery or OOO delivery is supported at STA 2206 (since all MSDUs are complete in the reorder buffer), STA 2204 may transmit to STA 2206 frame 2220. For example, frame 2220 may be a PPDU comprising a unit 2221 and data units 2222-1, 2222-2, 2222-3 and 2222-4. Unit 2221 may comprise a PHY preamble and a PHY header of frame 2220. Data units 2222-1, 2222-2, 2222-3 and 2222-4 may comprise the same MSDUs of data units 2212-1, 2212-2, 2212-3 and 2212-4 of frame 2210. The MSDUs of data units 2222-1, 2222-2, 2222-3 and 2222-4 may be associated with a same or a different sequence number as the MSDUs of data units 2212-1, 2212-2, 2212-3 and 2212-4. Sequence numbers of MSDUs in a buffer may change with a same offset for all MSDUs in a sequence, if they are to be transmitted. In example 2200, frame 2220 comprises all the data units with sequence numbers 1, 2, 3 and 4 since all data units were received successfully, and independent of whether STA 2206 can support IO delivery or OOO delivery.

On receiving frame 2220, STA 2206 may decode frame 2220 and determine the units that are received successfully or received in error. In an example, unit 2221 and data units 2222-1, 2222-2, 2222-3 and 2222-4 (with sequence numbers 1, 2, 3 and 4, respectively) may be received successfully. In an example, whether supporting IO delivery or OOO delivery, STA 2206 may forward the MSDUs of data units 2222-1, 2222-2, 2222-3 and 2222-4 (with sequence numbers 1, 2, 3 and 4, respectively) in the reorder buffer to the higher layer. In an example, STA 2206 may transmit to STA 2204 BA frame 2225 indicating data units 2222-1, 2222-2, 2222-3 and 2222-4 were received successfully.

After receiving BA frame 2215 and during its allocated transmission period, AP 2202 may transmit to STA 2204 frame 2230. In an example, frame 2230 may be a PPDU comprising unit 2231, wherein unit 2231 comprises PHY preamble and PHY header, and data unit 2232. Data unit 2232 may comprise a new data unit comprising sequence number 5.

On receiving frame 2230, STA 2204 may decode frame 2230 and determine the units that are received successfully or received in error. In an example, unit 2231 and data unit 2232 (with sequence number 5) may be received successfully. In an example, STA 2204 may transmit to AP 2202 BA frame 2235 indicating data unit 2232 was received successfully. In an example, STA 2204 may place the MSDU with sequence number 5 (of data unit 2232) in the reorder buffer. In another example, data units that are received successfully by the relay STA are not placed in the reorder buffer and may be directly forwarded sequentially (e.g., according to their sequence numbers) to the destination STA.

In an example, after transmitting BA frame 2235 and independent of the ability of STA 2206 to support IO delivery or OOO delivery, STA 2204 may transmit to STA 2206 frame 2240. Frame 2240 may be a PPDU frame comprising unit 2241, wherein unit 2241 comprises PHY preamble and PHY header, and data unit 2242 (with sequence number 5).

On receiving frame 2240, STA 2206 may decode frame 2240 and determine the units that are received successfully or received in error. In an example, unit 2241 and data unit 2242 (with sequence number 5) may be received successfully. In an example, independent of supporting IO delivery OOO delivery, STA 2206 may forward data unit 2242 (with sequence number 5) in the reorder buffer to the higher layer. In an example, STA 2206 may transmit to STA 2204 BA frame 2245 indicating data unit 2242 was received successfully. As illustrated in example 2200, the proposed invention efficiently works if all data units are received successfully, whether STA 2206 supports IO delivery or OOO delivery.

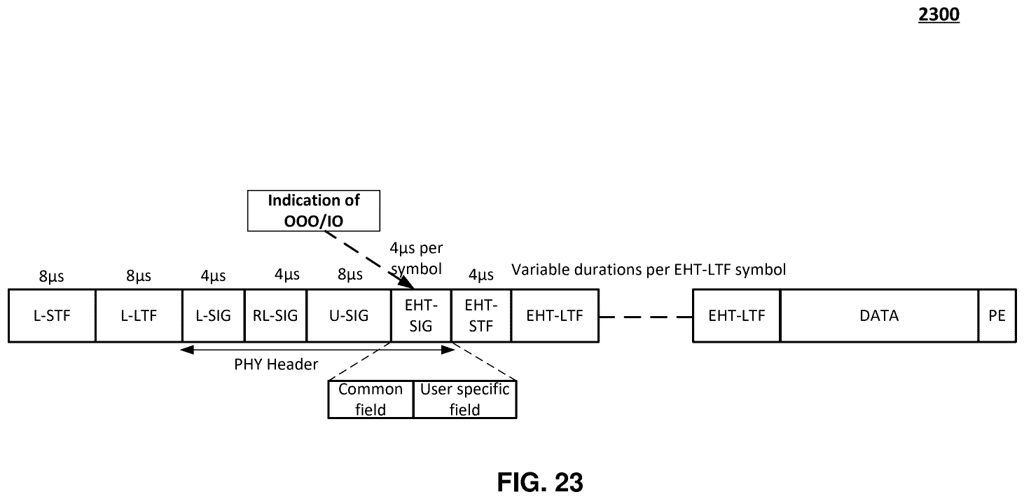

FIG. 23 illustrates an example PPDU 2300 that may be used in an embodiment. Example PPDU 2300 may be an embodiment of a PPDU that carries frame 1910 described above. As shown in FIG. 23, PPDU 2300 may comprise a legacy short training field (L-STF), a legacy long training field (L-LTF), a legacy signal field (L-SIG), a repeated L-SIG (RL-SIG), a universal signal field (U-SIG), an Extremely High Throughput (EHT) signal field (EHT-SIG), an EHT short training field (EHT-STF), one or more EHT long training field (EHT-LTF), a data field, and a packet extension (PE) field. In an implementation, the L-SIG, RL-SIG, U-SIG, and EHT-SIG form a PHY header of PPDU 2300.

The data field of PPDU 2300 may comprise a first data unit and a second data unit following the first data unit. In an embodiment, the PHY header of PPDU 2300 comprises an indication of whether transmission of the second data unit before the first data unit is allowed. In an embodiment, the indication may be provided in the EHT-SIG field of the PHY header. In an embodiment, the EHT-SIG may comprise a common field and a user specific field. The indication may be provided in one or the other of the common info field or the user specific field.

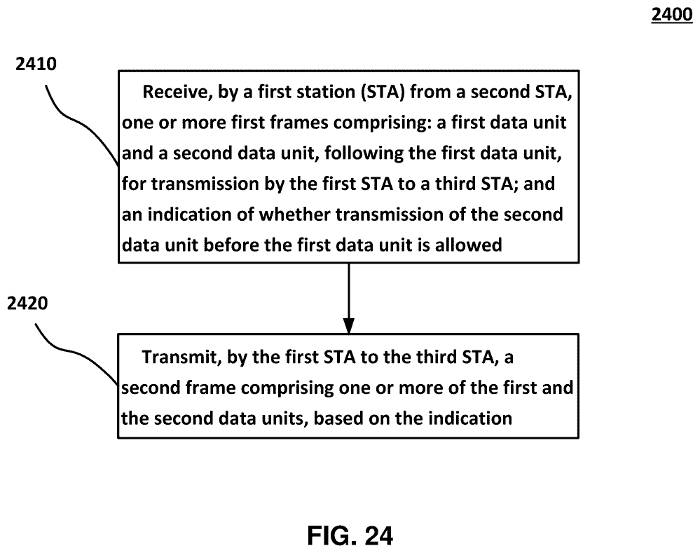

FIG. 24 illustrates an example process 2400, according to an embodiment. Example process 2400 is provided for the purpose of illustration only and is not limiting. Example process 2400 may be performed by a first STA, such as STA 1604, STA 1704, STA 1804, STA 1904, STA 2004, STA 2104 or STA 2204, for example, in the context of a relaying procedure.

As shown in FIG. 24, process 2400 may include, in step 2410, receiving, by a first STA from a second STA, one or more first frames comprising: a first data unit and a second data unit, following the first data unit, for transmission by the first STA to a third STA; and an indication of whether transmission of the second data unit before the first data unit is allowed.

In step 2420, process 2400 may include transmitting, by the first STA to the third STA, a second frame comprising one or more of the first and the second data units, based on the indication.

In an embodiment, the indication may comprise a first indication that transmission of the second data unit before the first data unit is to be performed when the first data unit is received in error. In an embodiment, where the first data unit is received in error, the second frame may comprise the second data unit. In an embodiment, the second frame may not comprise the first data unit. In an embodiment, where the first data unit is received in error, process 2400 may further comprise transmitting, by the first STA to the second STA, a third frame indicating the first data unit was received in error by the first STA. In an embodiment, the third frame may comprise a block acknowledgment (BA) frame. In an embodiment, process 2400 may further comprise receiving, by the first STA from the second STA, a fourth frame comprising the first data unit in response to the third frame. In an embodiment, process 2400 may further comprise transmitting, by the first STA to the third STA, a fifth frame comprising the first data unit.

In another embodiment, where the first data unit is received successfully, the second frame may comprise the first data unit. In an embodiment, the second frame may further comprise the second data unit.

In an embodiment, the indication may further comprise a second indication that transmission of the second data unit before the first data unit is not to be performed. In an embodiment, where the first data unit was received in error, the second frame may comprise the first data unit. In an embodiment, the second frame may further comprise the second data unit. In another embodiment, the second frame may not comprise the second data unit. In an embodiment, process 2400 may further comprise, before transmitting the second frame, transmitting, by the first STA to the second STA, a third frame indicating the first data unit was received in error by the first STA. In an embodiment, the third frame may comprise a block acknowledgment (BA) frame. In an embodiment, process 2400 may further comprise, before transmitting the second frame and in response to the third frame, receiving, by the first STA from the second STA, a fourth frame comprising the first data unit.

In an embodiment, the one or more first frames may comprise a sixth frame comprising the indication. In an embodiment, the sixth frame may comprise a management frame. In an embodiment, the management frame may comprise an action frame. In an embodiment, the one or more first frames may comprise a seventh frame comprising the first data unit and the second data unit. In an embodiment, receiving the one or more first frames may comprise receiving the sixth frame before receiving the seventh frame.

In another embodiment, the sixth frame may comprise at least one of the first data unit and the second data unit. In an embodiment, the sixth frame may comprise the first data unit and the second data unit. In another embodiment, where the sixth frame comprises the first data unit, the one or more first frames may further comprise a seventh frame comprising the second data unit. In an embodiment, receiving the one or more first frames may comprise receiving the sixth frame before receiving the seventh frame.

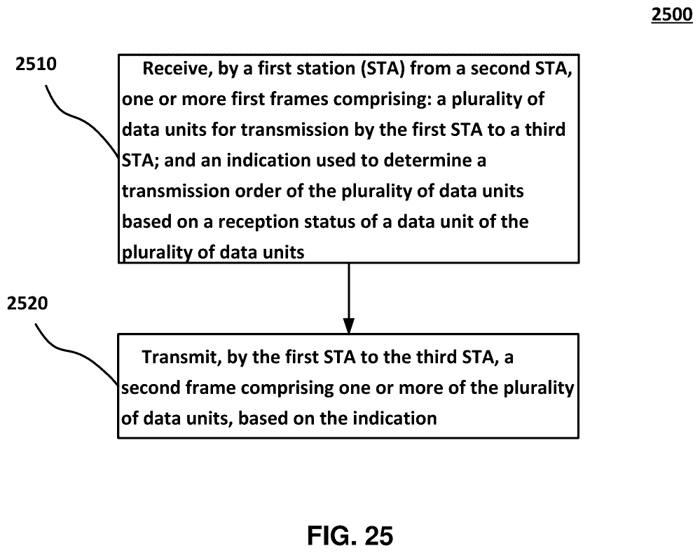

FIG. 25 illustrates an example process 2500, according to an embodiment. Example process 2500 is provided for the purpose of illustration only and is not limiting. Example process 2500 may be performed by a first STA, such as STA 1604, STA 1704, STA 1804, STA 1904, STA 2004, STA 2104 or STA 2204, for example, in the context of a relaying procedure.

As shown in FIG. 25, process 2500 may include, in step 2510, receiving, by a first STA from a second STA, one or more first frames comprising: a plurality of data units for transmission by the first STA to a third STA; and an indication used to determine a transmission order of the plurality of data units based on a reception status of a data unit of the plurality of data units.

In step 2520, process 2500 may include transmitting, by the first STA to the third STA, a second frame comprising one or more of the plurality of data units, based on the indication.

In an embodiment, the indication may comprise a first indication that transmission of the second data unit before the first data unit is to be performed when the first data unit is received in error. In an embodiment, where the first data unit is received in error, the second frame may comprise the second data unit. In an embodiment, the second frame may not comprise the first data unit. In an embodiment, where the first data unit is received in error, process 2500 may further comprise transmitting, by the first STA to the second STA, a third frame indicating the first data unit was received in error by the first STA. In an embodiment, the third frame may comprise a block acknowledgment (BA) frame. In an embodiment, process 2500 may further comprise receiving, by the first STA from the second STA, a fourth frame comprising the first data unit in response to the third frame. In an embodiment, process 2500 may further comprise transmitting, by the first STA to the third STA, a fifth frame comprising the first data unit.

In another embodiment, where the first data unit is received successfully, the second frame may comprise the first data unit. In an embodiment, the second frame may further comprise the second data unit.

In an embodiment, the indication may further comprise a second indication that transmission of the second data unit before the first data unit is not to be performed. In an embodiment, where the first data unit was received in error, the second frame may comprise the first data unit. In an embodiment, the second frame may further comprise the second data unit. In another embodiment, the second frame may not comprise the second data unit. In an embodiment, process 2500 may further comprise, before transmitting the second frame, transmitting, by the first STA to the second STA, a third frame indicating the first data unit was received in error by the first STA. In an embodiment, the third frame may comprise a block acknowledgment (BA) frame. In an embodiment, process 2500 may further comprise, before transmitting the second frame and in response to the third frame, receiving, by the first STA from the second STA, a fourth frame comprising the first data unit.

In an embodiment, the one or more first frames may comprise a sixth frame comprising the indication. In an embodiment, the sixth frame may comprise a management frame. In an embodiment, the management frame may comprise an action frame. In an embodiment, the one or more first frames may comprise a seventh frame comprising the first data unit and the second data unit. In an embodiment, receiving the one or more first frames may comprise receiving the sixth frame before receiving the seventh frame.

In another embodiment, the sixth frame may comprise at least one of the first data unit and the second data unit. In an embodiment, the sixth frame may comprise the first data unit and the second data unit. In another embodiment, where the sixth frame comprises the first data unit, the one or more first frames may further comprise a seventh frame comprising the second data unit. In an embodiment, receiving the one or more first frames may comprise receiving the sixth frame before receiving the seventh frame.

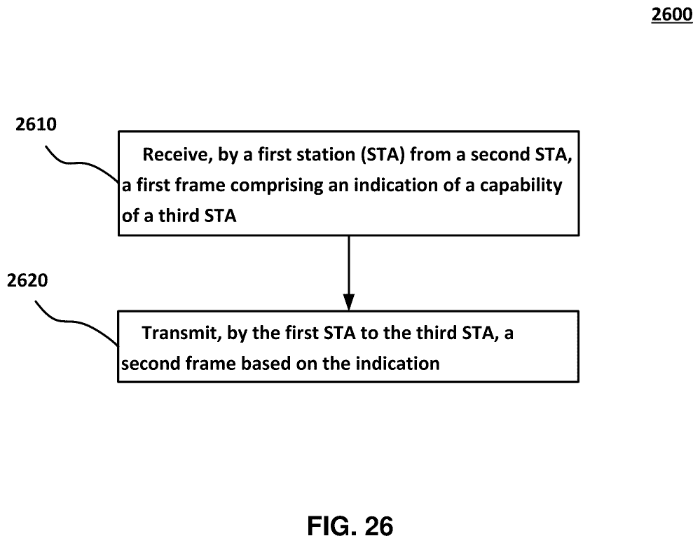

FIG. 26 illustrates an example process 2600, according to an embodiment. Example process 2600 is provided for the purpose of illustration only and is not limiting. Example process 2600 may be performed by a first STA, such as STA 1604, STA 1704, STA 1804, STA 1904, STA 2004, STA 2104 or STA 2204, for example, in the context of a relaying procedure.

As shown in FIG. 26, process 2600 may include, in step 2610, receiving, by a first station (STA) from a second STA, a first frame comprising an indication of a capability of a third STA. In an embodiment, the first frame may comprise a management frame. In an embodiment, the management frame may comprise an action frame.

In an embodiment, the capability may comprise a data unit reception/delivery capability. In an embodiment, the data unit reception/delivery capability may comprise an in-order reception/delivery capability or an out-of-order reception/delivery capability. In an embodiment, the capability may comprise a capability to perform out-of-order MPDU reception/delivery. In another embodiment, the capability may comprises any other STA capability than performing out-of-order MPDU reception/delivery, not limited to but comprising simultaneous transmit receive (STR) capability, beamforming capability and above 7 GHz band operation capability.

In an embodiment, the first STA may comprise a relay STA. In an embodiment, the second STA may comprise an access point (AP). In an embodiment, the third STA may comprise a destination STA.

In step 2620, process 2600 may include transmitting, by the first STA to the third STA, a second frame based on the indication.

1. A first station (STA) comprising:
one or more processors; and
memory storing instructions that, when executed by the one or more processors, cause the first STA to:
receive, from a second STA, one or more first frames comprising:
a first data unit and a second data unit, following the first data unit, for transmission by the first STA to a third STA; and
an indication of whether transmission of the second data unit before the first data unit is allowed; and
transmit, to the third STA, a second frame comprising one or more of the first and the second data units, based on the indication.

2. The first STA of claim 1, wherein the indication comprises a first indication that transmission of the second data unit before the first data unit is to be performed when the first data unit is received in error.

3. The first STA of claim 2, wherein the first data unit is received in error, and wherein the second frame comprises the second data unit.

4. The first STA of claim 3, wherein the second frame does not comprise the first data unit.

5. The first STA of claim 2,
wherein the first data unit is received in error, and
wherein the memory stores instructions that, when executed by the one or more processors, further cause the first STA to:
transmit, to the second STA, a third frame indicating the first data unit was received in error by the first STA.

6. The first STA of claim 2, wherein the first data unit is received successfully, and wherein the second frame comprises the first data unit.

7. The first STA of claim 1, wherein the indication further comprises a second indication that transmission of the second data unit before the first data unit is not to be performed.

8. The first STA of claim 7, wherein the first data unit is received in error, and wherein the second frame comprises the first data unit.

9. The first STA of claim 7, wherein the memory stores instructions that, when executed by the one or more processors, further cause the first STA to, before transmitting the second frame, transmit, to the second STA, a third frame indicating the first data unit is received in error by the first STA.

10. The first STA of claim 1, wherein the one or more first frames comprise:
a third frame comprising the indication, the third frame comprising a management frame or an action frame, and
a fourth frame comprising the first data unit and the second data unit, and
wherein receiving the one or more first frames comprises receiving the third frame before receiving the fourth frame.

11. The first STA of claim 1, wherein the one or more first frames comprise a further indication of whether the third STA is capable of receiving the second data unit before the first data unit, and
wherein the transmitting, to the third STA, of the second frame is further based on the further indication.

12. The first STA of claim 11, wherein the further indication indicates a capability, of the third STA, to perform out-of-order medium access control (MAC) protocol data unit (MPDU) reception.

13. An access point (AP) comprising:
one or more processors; and
memory storing instructions that, when executed by the one or more processors, cause the AP to:
transmit, to a first station (STA), one or more first frames comprising:
a first data unit and a second data unit, following the first data unit, for transmission by the first STA to a second STA; and
an indication of whether transmission of the second data unit before the first data unit is allowed.

14. The AP of claim 13, wherein the indication comprises a first indication that transmission of the second data unit before the first data unit is to be performed when the first data unit is received in error.

15. The AP of claim 13, wherein the one or more first frames comprise:
a second frame comprising the indication, the second frame comprising a management frame or an action frame, and
a third frame comprising the first data unit and the second data unit, and
wherein transmitting the one or more first frames comprises transmitting the second frame before transmitting the third frame.

16. The AP of claim 13, wherein the one or more first frames comprise a further indication of whether the second STA is capable of receiving the second data unit before the first data unit.

17. A non-transitory computer-readable medium comprising instructions that, when executed by one or more processors of a first station (STA), cause the first STA to:
receive, from a second STA, one or more first frames comprising:
a first data unit and a second data unit, following the first data unit, for transmission by the first STA to a third STA; and
an indication of whether transmission of the second data unit before the first data unit is allowed; and
transmit, to the third STA, a second frame comprising one or more of the first and the second data units, based on the indication.

18. The non-transitory computer-readable medium of claim 17, wherein the indication comprises a first indication that transmission of the second data unit before the first data unit is to be performed when the first data unit is received in error.

19. The non-transitory computer-readable medium of claim 18, wherein the first data unit is received in error, and wherein the second frame comprises the second data unit.

20. The non-transitory computer-readable medium of claim 17, wherein the indication further comprises a second indication that transmission of the second data unit before the first data unit is not to be performed,
wherein the first data unit was received in error, and
wherein the second frame comprises the first data unit.
